(19) United States
(12) Patent Application Publication
(10) Pub. No.: US 2024/0348658 A1
(43) Pub. Date: Oct. 17, 2024

(54) METHOD AND APPARATUS FOR SECURITY APPLICATION BALANCING USING A PACKET SWITCH

(71) Applicant: CORSA TECHNOLOGY INC., Kanata (CA)

(72) Inventors: Adam KULAGOWSKI, Warsaw (PL); Tom KU, Cupertino, CA (US); Carolyn RAAB, Low (CA)

(21) Appl. No.: 18/633,055

(22) Filed: Apr. 11, 2024

Related U.S. Application Data
(60) Provisional application No. 63/495,983, filed on Apr. 13, 2023.

(51) Int. Cl. H04L 9/40; H04L 45/00

(52) U.S. Cl. CPC H04L 63/20; H04L 45/38; H04L 63/0236

(57) ABSTRACT

Methods and apparatus for statefully load balancing bidirectional packet flows over a plurality of identical instances of a security application or of a security appliance using a generic packet switch and a monitoring agent are disclosed including the provisioning of spare security application instances or spare security appliances and minimizing redistribution of packet flows from the failure of a security application instance or of a security appliance.

### RELATED APPLICATIONS

This application is a non-provisional application which claims the benefit of U.S. Provisional Patent Application No. 69/495,983 filed on Apr. 13, 2023.

### TECHNICAL FIELD

Embodiments herein generally relate to the field of communications networks and more specifically to the handling of data packets to enhance the security of communications networks and scale network security infrastructure with traffic volume.

### BACKGROUND

Network security protocol systems provide security protocols to communications networks. These protocols could include, for example, firewalling, in which a barrier to malicious traffic between a trusted network such as a private corporate network and another untrusted network, such as the Internet, for example, is provided. Network security protocols could also or instead include: monitoring and logging of network traffic; intrusion detection; intrusion prevention; decryption of encrypted traffic for enhanced visibility. Malicious attacks on communications networks are growing in sophistication and size. Scalable network security protocol systems could beneficially improve network security.

### BRIEF DESCRIPTION OF THE DRAWINGS

The embodiments herein will be better understood from the following detailed description with reference to the drawings, in which:

FIG. 1A is a block diagram of example host machines hosting multiple virtual machines;

FIG. 1B is a block diagram of Virtual Machine clusters spread across multiple host machines;

FIG. 1C is a block diagram depicting an example security appliance implementation in a communications network;

FIG. 2A is a block diagram of an example security control point;

FIG. 2B is a flow chart detailing the steps in a method for load balancing across multiple security protocol subsystems according to one aspect of the present invention;

FIG. 3A is a flowchart detailing a method for managing security protocol subsystems according to another aspect of the present invention;

FIG. 3B is a flowchart detailing the steps in a method for load balancing across multiple security protocol subsystems in the event a destination virtual IP address is unreachable;

FIG. 4 is a block diagram of another example security control point with one or more spare security protocol subsystems;

FIG. 5 is a flowchart detailing the steps in a method for load balancing across multiple security protocol subsystems and for managing these multiple security protocol subsystems in the event there is a failure detected in one of the security protocol subsystems;

FIG. 6 is a flowchart detailing the steps in a method for managing multiple security protocol subsystems in the event a failure of a security protocol subsystem is detected; and

FIG. 7 is a flowchart detailing the steps in a method for managing multiple security protocol subsystems in the event a previously failed security protocol subsystem is recovered.

### DETAILED DESCRIPTION

All illustrations of the drawings are for the purpose of describing selected versions of the present invention and are not intended to limit the scope of the present invention.

Communication traffic can take any of various forms and include any of various types of information. Data flows and data packets as referenced herein are examples of communication traffic to which the embodiments disclosed herein could be applied. The present disclosure is not necessarily limited to transfer of data, or to data or information that is specifically formatted into packets. Features that are disclosed herein with reference to data flows or data traffic could be applied to communication traffic other than data flows, to communication traffic that is formatted into blocks other than packets, and/or to communication traffic that includes content or payloads other than strictly data.

Data packets are organized according to protocols such as, for example, the Transmission Control Protocol (TCP) or the File Transfer Protocol (FTP). A data packet is typically organized into a header and a payload. The header contains information about the data packet such as its source and destination address. The payload is the actual data to be transferred.

A unidirectional packet “flow” is a unidirectional movement of data packets with a set of common characteristics. A set of common characteristics could be, for example, the packets' Internet Protocol (IP) source and destination addresses, IP protocol version, source and destination port addresses or numbers and IP class of service. A subset of one or more of these characteristics, and/or other packet characteristics, could be used to define a unidirectional packet flow. The set of common characteristics which define a unidirectional packet flow is also called the flow key or the flow identifier. The flow key could be the IP protocol and the IP source and destination addresses of the packet (a 3-tuple). The flow key could also be the IP protocol, the IP source and destination addresses and the port source and destination addresses of the packet (a 5-tuple).

Data communications could be two-way and comprise a first unidirectional originating packet flow sent from a first host to a second host and a corresponding second unidirectional return packet flow sent from the second host to the first host in response to the first unidirectional packet flow. For example, a first host could send a request to a second host for the contents of a web page. The second host could then send the web page to the first host. Two-way communications could use any two-way communications protocol such as TCP, for example. The combination of a unidirectional packet flow and its corresponding unidirectional return packet flow is called a bidirectional packet flow. A unidirectional packet flow may also be referred to herein as a unidirectional flow, and similarly a bidirectional packet flow may also be referred to herein as a bidirectional flow.

### Scale Up/Scale Out

Scaling network security protocol systems to meet increased communication traffic volumes could be a challenge. One approach is to “scale up”. In the scale up approach, increasingly larger capacity network security protocol systems are installed to handle increases in the volume of communication traffic.

Another approach is to “scale out”. In this approach, the security task is spread across multiple network security protocol sub-systems running in parallel and additional network security protocol sub-systems are added incrementally to keep up with increases in traffic volume. Network security protocol sub-systems could also be removed incrementally with decreases in traffic volumes.

For brevity, the term security systems and security appliances will be used to refer to network security protocol systems through the remainder of the text.

### Virtualization

One way to implement scale out is using virtualization. In this approach, instead of using purpose-built network security protocol hardware, “virtual” security appliances are implemented using one or more hardware components such as, for example, a multi-processor x86 server and/or other computing hardware to execute security application software. A security application, when executed, could cause or otherwise configure computing hardware to perform all the protocols or functions of a physical security appliance. Examples of security applications include firewalls, Intrusion Detection Systems (IDSs), Intrusion Prevention Systems and Network Security Monitors. Virtualization could be more economical than using purpose-built security hardware due to the relatively low cost and wide availability of general-purpose computing hardware and its continually improving performance.

Virtualization could also allow security capacity to be adjusted faster than with purpose-built security hardware. For example, additional instances of a security application could be quickly created and added to a server to meet higher levels of traffic without deploying any additional purpose-built security hardware. Conversely, at low traffic levels, security application instances could be removed to save on software licensing costs. The different instances of the same security application could be configured identically with identical security policies and identical security behaviors. Such identically configured instances of the same security application may be referred to as homogeneous instances, and/or as providing homogeneity among multiple security application instances. Security application instances could be considered to be network security protocol sub-systems.

A security application could run on a Virtual Machine (VM). A VM is a software emulation of a computer system. A VM runs on a physical computer or computing hardware, such as for example, a multi-processor x86 server. This physical computer is frequently referred to as a “host” machine. Multiple VMs can run on the same host machine. A VM could have configurable amounts of resources, such as computing, memory and/or communication bandwidth resources.

VMs can be created or removed from the host machine. A VM can run its own operating system. VMs on the same host machine can run different operating systems or versions of operating systems. For example, one VM might run a version of the Windows® operating system while a second VM on the same host machine might run a version of the Linux® operating system.

In one embodiment, a VM runs one and only one instance of a security application.

VMs could be organized into VM “clusters” with all VMs in a cluster running identical instances of the same security application and each instance configured with identical security policies and security behaviors and all VNS communicating with each other. In this sense, a VM cluster may also be considered homogeneous.

A VM cluster could run on a single host machine or multiple machines.

There could be multiple VM clusters, each running on its own host machine.

An example of a VM cluster is the HA4 firewall cluster made by Palo Alto Networks of Santa Clara California.

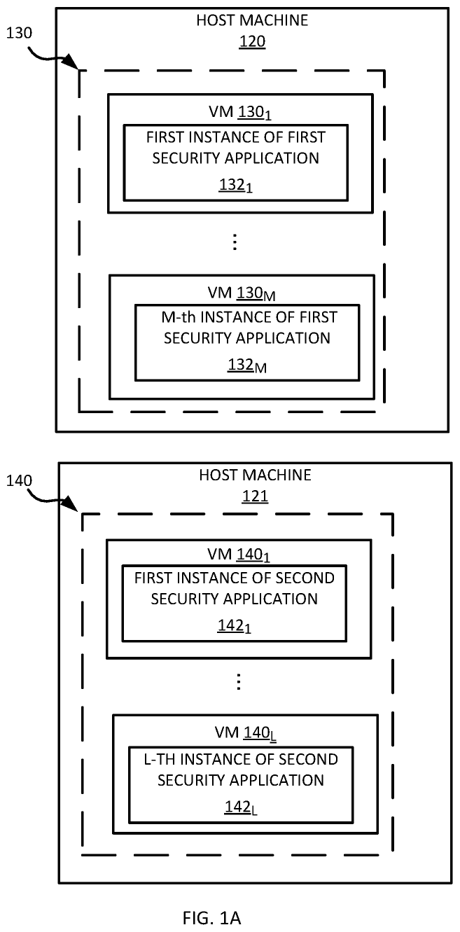

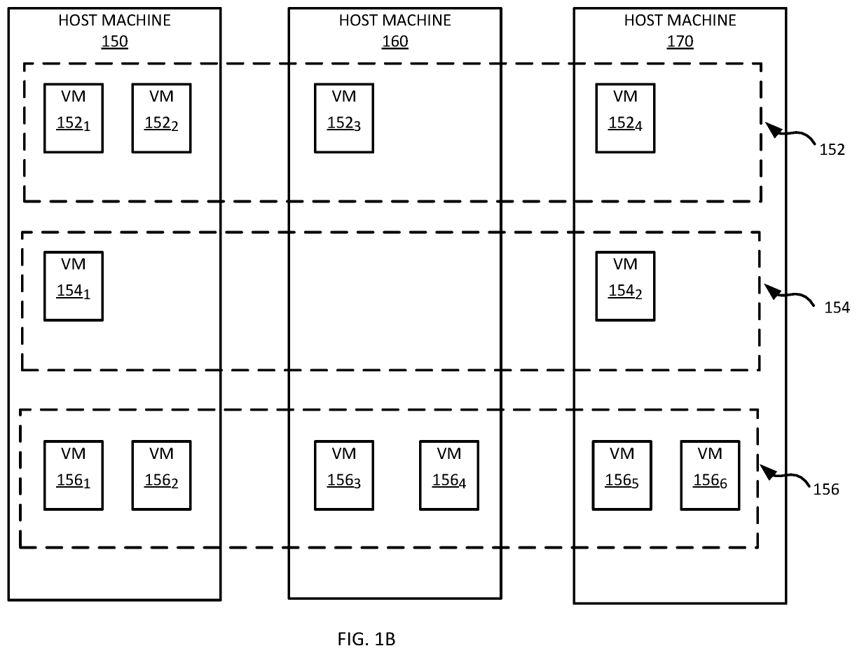

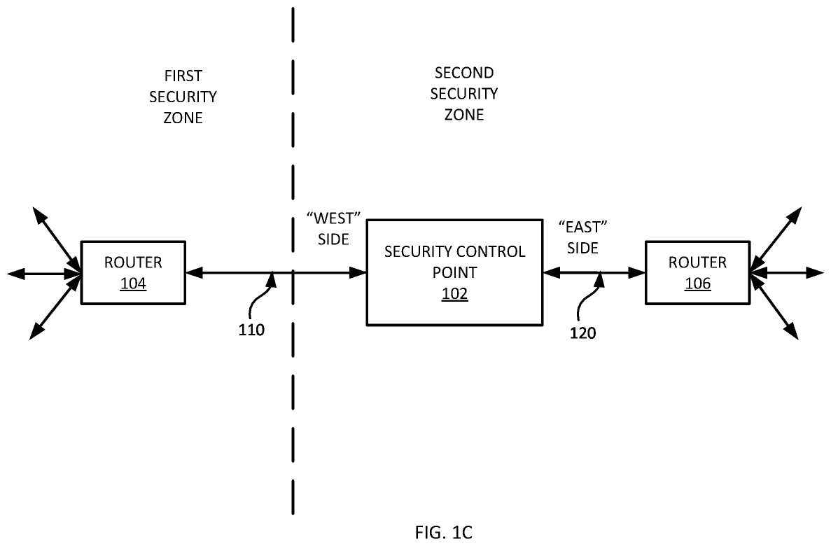

FIG. 1A is a block diagram of example host machines hosting multiple VMs. Host machine 120 hosts a first VM cluster 130. Host machine 121 hosts a second VM cluster 140.

VM cluster 130 comprises “M” individual VMs 1301 . . . 130M. VMs 1301 . . . 130M each run respective instances 1321 . . . 132M of a first security application.

VM cluster 140 comprises “L” individual VMs 1401 . . . 140L. VMs 1401 . . . 140L each run respective instances 1421 . . . 142L of a second security application. In some implementations first security application instances 1321 . . . 132M are identical to second security applications 1421 . . . 142L. In some implementations host machines 120 and 121 are in different physical locations to protect the security system against a complete failure due to a catastrophic event such as a fire, flood, earthquake etc.

FIG. 1A is an example only and host machines 120 and 121 could instead host multiple VM clusters running additional instances of additional security applications. In general, it is expected that all instances of any particular security application will be running in one VM cluster. However, it should be appreciated that in general there may be one or more VM clusters to run one or more instances of a security application.

A VM cluster could also be spread across more than one host machine. FIG. 1B is a block diagram of VM clusters spread across multiple host machines. VM cluster 152 comprises four VMs 1521 . . . 1524 and is spread across host machines 150, 160 and 170 with VMs 1521 and 1522 running on host machine 150, VM 1523 running on host machine 160 and VM 1524 running on host machine 170. VM cluster 154 comprises two VMs 1541 and 1542 and is spread across host machines 150 and 170. VM cluster 156 comprises six VMs 1561 . . . 1566 spread across host machines 150, 160 and 170.

Examples of security applications that could run on VMs such as any of the VMs 1301 . . . 130M and 1401 . . . 140L of FIG. 1A and/or any of the VMs 1521 . . . 1524, 1541 and 1542, and 1561 . . . 1566 in FIG. 1B include firewalls, Intrusion Detection Systems (IDS), Intrusion Prevention Systems and Network Security Monitors.

A security appliance could be placed at the boundary between two different security zones and the security zones could connect to each other through the security appliance.

FIG. 1C is a block diagram depicting an example security appliance implementation in a communications network. Security control point 102 is positioned between packet routers 104 and 106 and all packet traffic travelling between routers 104 and 106 passes through security control point 102. Router 104 is in a first security zone and router 106 is in a second security zone. A security zone is a collection of networked hosts (e.g., servers, user workstations) with a common set of access security policies. Connections 110 and 120 provide connectivity between security control point 102 and routers 104 and 106, respectively. Connections 110 and 120 could be any of various types of wired or wireless connection media used to implement network connectivity, including optical fiber, co-axial cable, twisted pairs, Wi-Fi, wireless, microwave connectivity or any combination thereof.

In one embodiment, router 106 is a gateway router placed at the perimeter of a private network such as a Local Area Network (LAN) and router 104 could be at an Internet Service Provider or an internet exchange peering point. In this embodiment, security control point 102 connects the two different networks and could protect the private network from attacks from the Internet.

FIG. 1C is an example only and other placements of a security control point are possible. For example, routers 104 and 106 could both be inside a corporate network. Router 104 could be inside one corporate security zone, router 106 could be inside a different corporate security zone, and security control point 102 could be placed between them. In this case, security control point 102 could protect each security zone from attacks originating in the other security zone.

In general, security control point 102 connects two different network nodes in two different security zones and security control point 102 mitigates attacks on one security zone, and potentially either security zone, from the other security zone.

Security control point 102 is bidirectional. A packet can enter security control point 102 at its “WEST” side from router 104 and exit from the security control point's “EAST” side to router 106. A packet can also enter security control point 102 at its “EAST” side from router 106 and exit from the “WEST” side to router 104. Packets could also enter and exit from the same side (e.g., enter and exit security control point 102 at its “WEST” side). This is commonly called “hairpinning”.

Security control point's “EAST” and “WEST” sides” referenced herein are intended solely to refer to logical rather than physical sides of the security control point and illustrate different directions of packet flow. For example, an interface to receive or transmit packet traffic need not be located at a physical side of a security control point. Also, “EAST” side and “WEST” side traffic could be received by physically adjacent receive interfaces that are not located at different physical sides of a security control point, or even by a single physical interface that receives multiplexed incoming traffic for both “EAST” to “WEST” and “WEST” to “EAST” traffic flow directions. Similarly, “EAST” side and “WEST” side transmit interfaces need not be located at physically different sides of a security control point, or a single transmit interface could be used to transmit outgoing multiplexed “EAST” side and “WEST” side traffic from a security control point.

### Security Control Point

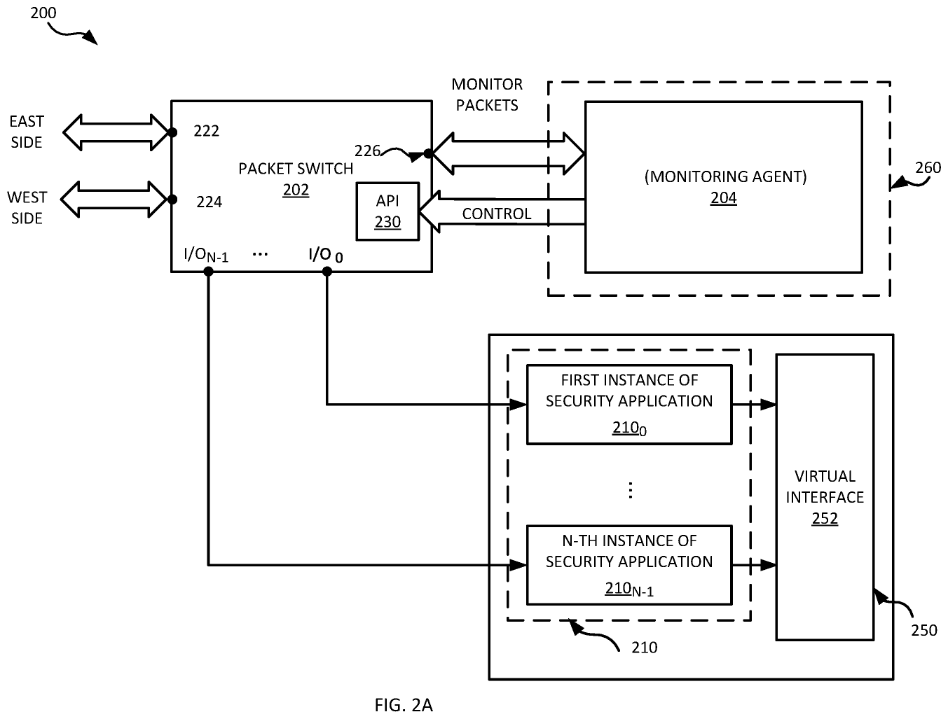

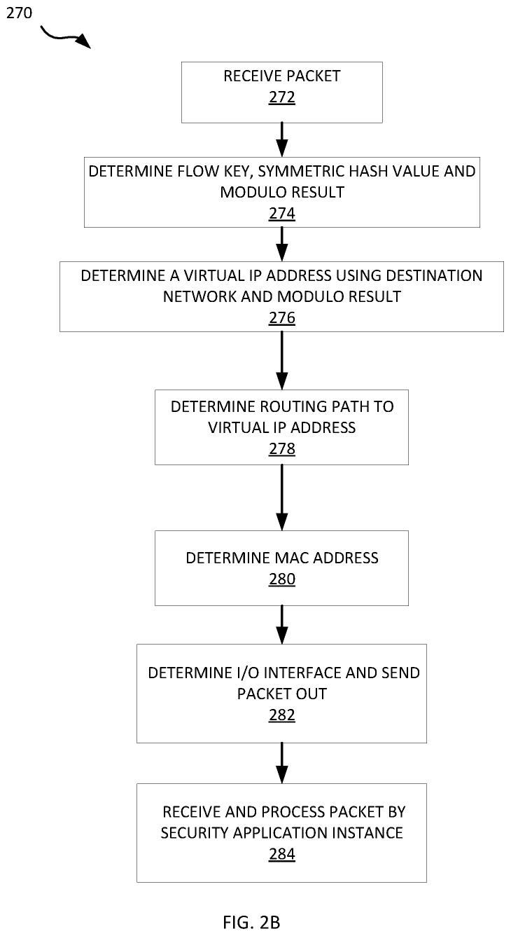

FIG. 2A is block diagram of an example security control point. Security control point 200 comprises packet switch 202 and host machines 250 and 260.

Host machines 250 and 260 could be general purpose computing hardware such as servers.

Host machine 250 hosts security application cluster 210 and virtual interface 252.

Security application cluster 210 comprises security application instances 2100 210N−1. Security applications instances 2100 . . . 210N−1 could run on virtual machines as described previously and be instances of any one of the types of security applications described previously.

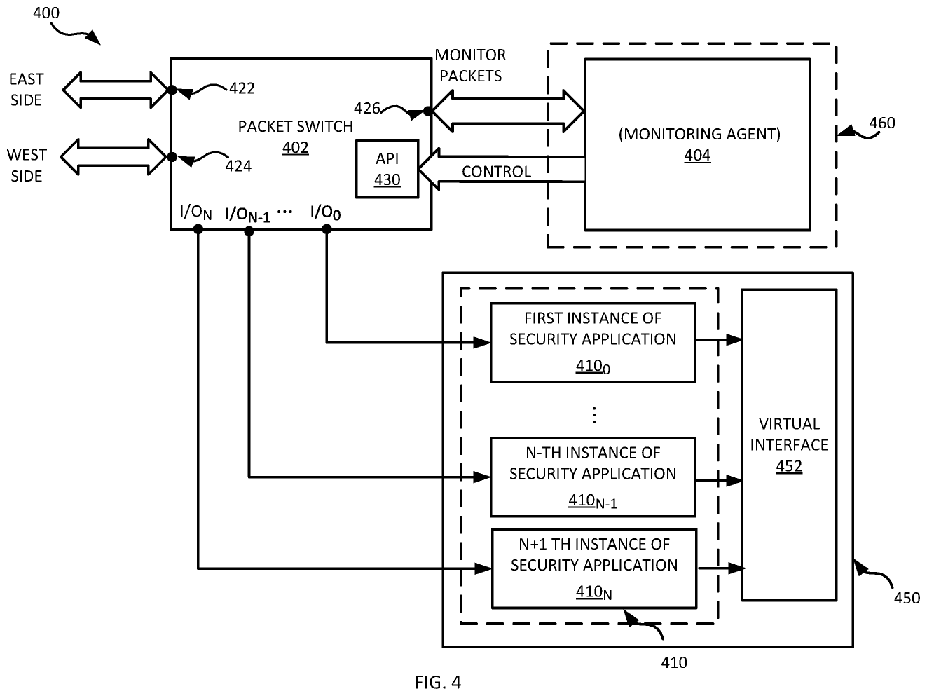

Virtual interface 252 receives packets processed by any of security application instances 2100 . . . 210N−1 and forwards them back to packet switch 202. For simplicity the return path is not shown in FIG. 4. A virtual interface is an abstract or virtualized representation of a network interface. A virtual interface could allow more than network interface on a single physical interface or connection. A virtual interface could also combine two physical interfaces together. Virtual interfaces provide many of the same features as physical interfaces.

Host machine 260 hosts monitoring agent 204. Monitoring agent 204 could be a software application and monitor and control the behavior of packet switch 202 and/or security applications instances 2100 . . . 210N−1. Monitoring agent 204 could also be termed a controller.

Packet switch 202 comprises a plurality of bidirectional input/output interfaces I/O0 . . . I/ON−1, monitor interface 226, bi-directional interfaces 222 and 224 and Application Programing Interface 230 (API).

Packet switch 202 could be a general-purpose packet switch and I/O interfaces I/O0 . . . I/ON−1 could be general purpose input/output interfaces. Packet switch 202 could be capable of switching packets received at any one of interfaces I/O0 I/ON−1, 222, 224 and 226 to any other interface. Although packet switch 202 is described as a “switch” this term is used generically to describe its action of switching a packet received at one of its interfaces to another of its interfaces.

Packet switch 202 could be a generic off the shelf device such as for example the Cisco NEXUS 9364C Ethernet switch or the or the Nvidia SN3000 series.

Packet switch 202 could also comprise an Application Specific Integrated Circuit (ASIC) (not shown).

Packet switch 202 connects to security application instances 2100 . . . 210N−1 through respective input/output interfaces I/O1 . . . I/ON−1. Input/output interfaces I/O1 . . . I/ON−1 could be physical interfaces or virtual interfaces. Virtual interfaces could be enabled by a variety of protocols, including, for example, Virtual Routing and Forwarding (VRF) or Virtual Local Area Network (VLAN) tags. There is a one-to-one correspondence between input/output interfaces I/O1 . . . I/ON−1 and security application instances 2100 . . . 210N−1.

FIG. 2A is an example only and other configurations are possible. For example, monitoring agent 204 could instead be hosted on the same host machine as security application instances 2100 . . . 210N−1. For example, monitoring agent 202 could be hosted with security application instances 2100 . . . 210N−1 on host machine 250 and there might be no separate host 260.

It could, however, be beneficial for a monitoring agent such as monitoring agent 204 to be hosted on a separate host machine from security application instances 2100 . . . 210N−1. If for example, host machine 250 were to become unstable, monitoring agent 204 could be unaffected and could detect and signal the instability or failure of host 250 and/or security application instances 2100 . . . 210N−1.

Security application cluster 210 could instead of being hosted on a single machine be hosted across multiple host machines.

Interfaces 222 and 224 could be single interfaces or a group of interfaces.

Further variations on the security control point arrangement of FIG. 2A are also possible. The security application instances could be security hardware appliances rather than hosted software instances. For example, there could be no host 250 and security instances 2100 . . . 210N−1 could be hardware instances. Hardware instances could be dedicated security appliances such as for example, one of the Fortinet 600F series of security appliances manufactured by Fortinet of Sunnyvale California. The hardware instances could perform similar security functions as those described for security application instances 2100 . . . 210N−1.

Packets traveling in the EAST to WEST direction are received at interface 222 of packet switch 202. Packets traveling in the WEST to EAST direction are received at interface 224 of packet switch 202.

Packet switch 202 could forward a packet received at one of interfaces 222 and 224 to one of security application instances 2100 . . . 210N−1 through one of input/output interfaces I/O0 . . . I/ON−1. Packet switch 202 could be configured to distribute received packet flows between security application instances 2100 . . . 210N−1 as evenly as possible. This is often referred to as load balancing.

Packet switch 202 could have built-in Equal Cost Multi-Path (ECMP) functionality and load balance traffic across security application instances 2100 . . . 210N−1 using this functionality. ECMP is a packet flow routing strategy whereby packet flows for a single destination can be sent over multiple paths with equal routing priority. However, all packets in a particular flow take the same path.

### Stateful Load Balancing

It could be desirable for the load balancing across security application instances such as security application instances 2100 . . . 210N−1 to be “stateful”. In stateful load balancing all packets in a packet flow are intended to be sent to the same security application instance by the load balancer rather than potentially distributing the flow's packets across multiple security application instances.

Stateful load balancing could minimize the disruption to communications caused by the removal or failure of a security application instance. Referring to FIG. 2A, if communication traffic is being statefully load balanced across the “N” instances of a security application 2100 . . . 210N−1 and one instance is removed or failed (for example 2100), then any packet flow assigned to the removed or failed security instance could be disrupted. However, flows assigned to the remaining instances (2201 . . . 220N−1) might not be disrupted by the removal or failure of the security application instance as they would continue to be handled by the remaining security application instances to which they are assigned. If, however, load balancing is not stateful then it is possible that some packets from different flows might be assigned to the removed or failed security application instance. In this case it would be possible for all these flows to be disrupted, even if only a few of their packets had been sent to the removed or failed security application instance.

A security application instance could be removed for any of several reasons. For example, the security application might need to be upgraded or replaced with a new version. In this case, to minimize traffic disruption, the security control point's security application instances could be removed one at a time and replaced with upgraded or new versions of the application. As another example, the number of security application instances might not be optimal. There could be too little traffic to justify the number of security application instances that are running. Each instance could incur a software license fee and the amount of traffic might not justify the expense. As another example, a security instance might require removal because it has stopped working and processing packets (“crashed”). Deliberate removal of a security application instance could be considered as a failure of the security application instance in that the security application instance is no longer available to process packets and could be treated in the same manner as a failure of the security application instance. References to a failure of a security application instance herein should be interpreted as including removal of the security application instance.

The communication link between a security application instance and the packet switch might fail and packets might not be able to be sent to and/or received from the security application instance. Failure of the communication link could be considered as a failure of the security application instance and could be treated in the same manner as a failure of the security application instance. References to a failure of a security application instance herein should be interpreted as including failure of the communication link to/from the security application instance.

### Bidirectional Stateful Load Balancing

It could be advantageous for the load balancing of bidirectional flows to be stateful. In bidirectional stateful load balancing all packets in a bidirectional flow are passed to the same security application instance by the load balancer. For example, all packets in a flow entering packet switch 202 from the EAST side at bidirectional interface 222 and all packets in the corresponding return flow entering from the WEST side at bidirectional port 224 would be passed to the same security application instance (one of security application instances 2100 . . . 210N−1).

Bidirectional stateful load balancing could be advantageous for certain types of security services, such as for example, Transport Layer Security (TLS) or Secure Socket Layer (SSL) decryption.

Bidirectional stateful load balancing could also be advantageous from a security application instance loading perspective. The volume of data in a first unidirectional flow and its corresponding unidirectional return flow can be quite different. For example, the data volume in a unidirectional flow consisting of a request for an image from a web site could be much smaller than the data volume of the corresponding return flow carrying the image. The data volume difference between the two flows could be more effectively averaged out if they are both sent to the same security application instance than if they were sent to different instances.

Stateful load balancing could be implemented by hashing the flow key. Hashing is a mathematical operation which maps data of arbitrary size to a fixed and usually smaller size number.

Bidirectional stateful load balancing could be implemented using a directionally symmetric hashing. A directionally symmetric hash could produce identical hash values for all packets in a given bidirectional flow.

Packets in a unidirectional flow and packets in the corresponding unidirectional return flow typically have their IP source and destination addresses transposed and their source and destination port numbers transposed. For example, the IP source address of the unidirectional flow is the IP destination address of the corresponding unidirectional return flow and the IP destination address of the unidirectional flow is the IP source address of the corresponding unidirectional return flow. Similarly, the source port number of the unidirectional flow is the destination port number of the corresponding unidirectional return flow and the destination port number of the unidirectional flow is the source port number of the corresponding unidirectional return flow.

A directionally symmetric hash could produce the same hash result regardless of whether the source and destination IP addresses and port numbers are transposed. For example, the directionally symmetric hash might perform an exclusive OR of the source and destination IP addresses and an exclusive OR of the source and destination port numbers as part of the hashing operation.

The hash result might be subject to a modulo operation based on the number of security application instances. For example, if there were “N” instances of a security application then a modulo N operation could be performed on the hash result to return a value from 0 to N−1. The modulo result could then be used to determine which of the N security application instances to assign the processing of the packet to. For example, a modulo result of “M” could result in the packet being assigned to be processed by the M-th security application instance.

Referring to FIG. 2A, directionally symmetric hashing of a packet's flow key to produce a hash result and performing a modulo operation on the hash result could both be done by packet switch 202 and could provide for stateful load balancing of bidirectional packet flows by packet switch 202 over security application instances 2100 . . . 210N−1.

A packet could be directed to one of the input/output interfaces I/O0 . . . I/ON−1 of packet switch 202 based on the modulo result. The packet switch could have built-in ECMP functionality and the symmetric hash calculation, modulo operation and distribution of packets to the switch's output ports could be done using this built in ECMP functionality. The symmetric hash calculation and modulo operation could be done in hardware by an Application Specific Integrated Circuit (ASIC) residing in the packet switch (not shown) and could be done efficiently and at high data rates.

Some of the ECMP functionality of packet switch 202 could be configured by monitoring agent 204. Packet switch 202 could comprise a routing table (not shown). A routing table is a table of rules describing how packets should be handled to reach their destination networks. A routing table entry specifies where a packet switch should send a packet (the routing path) to reach a particular destination network, such as, for example, the internet. The particular destination network could be specified using an IP destination address or range of IP destination addresses. The routing path could be another IP address. The routing path is also sometimes referred to as the next hop.

Monitoring agent 204 could create a plurality of routing paths for a particular destination network. It could create routing paths corresponding to each of security application instances 2100 . . . 210N−1 and intended to send packet flows through each of security application instances 2100 . . . 210N−1. For example, monitoring agent 204 could create N possible routing paths in the routing table of packet switch 202 corresponding to respective security application instances 2100 . . . 210N−1. Packet switch 202 could determine which particular routing path of the plurality of routing paths to send a packet flow to using its built-in ECMP functionality.

Monitoring agent 204 could create routing paths to a destination network using virtual IP addresses. A virtual IP address is an IP address that does not correspond to an actual network device (physical or virtual). For example, referring to FIG. 2A, the respective routing paths corresponding to security application instances 2100 . . . 210N−1 could be the virtual IP addresses 169.254.10.0 to 169.254.10.N−1 and these addresses would not be the actual IP addresses of security application instances 2100 . . . 210N−1 or of any other devices (physical or virtual) on the local network.

It should be clear that the configuration detailed in this document allows for, among others, load balancing across multiple security protocol subsystems for data traffic being sent to a particular destination network. The configuration can allow for one or more destination virtual IP addresses for each destination network. Multiple paths to that destination network through different security protocol subsystems can be implemented by way of the routing table. Since multiple routing paths to a single destination network are possible, this allows for load balancing incoming data traffic (destined for a single destination network) across multiple security protocol subsystems. Each different MAC address can then be mapped to a different I/O port/interface and, since each I/O port corresponds to a specific security protocol subsystem, this allows for different paths for different security protocol subsystems. Load balancing across these different security protocol subsystems is therefore possible for multiple data packet flows that are heading to the same destination network. Multiple data packet flows can then traverse the system such that different packet flows pass through/are processed by different security protocol subsystems but these different packet flows still end up in the same destination network. The load balancing is stateful such that all packets in a bi-directional packet flow pass through the same security protocol sub-system.

Table 1.1 is an example routing table in which the destination address (the internet) has four virtual IP address routing paths. The four possible routing paths are virtual IP addresses 169.254.10.0 to 169.254.10.3. Table 1.1.1 shows the correspondence between the routing paths 169.254.10.0 to 169.254.10.3 and the security application instances 2100 . . . 210N−1.

Table 1.1 is an example only and the virtual IP addresses need not be consecutive and the routing table could contain additional entries for other destinations.

TABLE 1.1
Example Routing Table

| Destination | Virtual IP Routing Path |
|---|---|
| Internet | 169.254.10.0 |
| | 169.254.10.1 |
| | 169.254.10.2 |
| | 169.254.10.3 |

TABLE 1.1.1
Virtual IP Address Routing path to Security
Application Instance correspondence

| | Corresponding Security |
|---|---|
| Virtual IP Routing Path | Application Instance |
| 169.254.10.0 | 210₀ |
| 169.254.10.1 | 210₁ |
| 169.254.10.2 | 210₂ |
| 169.254.10.3 | 210₃ |

A routing table could further include entries describing respective routing paths to respective virtual IP addresses. These respective routing paths might be the IP addresses of an interface such as virtual interface 252. For example, the respective routing paths to virtual IP addresses 169.254.10.0 to 169.254.10.N−1 could be, respectively, IP addresses 169.254.11.0 to 169.254.11.N−1. IP addresses 169.254.11.0 to 169.254.11.N−1 could be IP addresses of an interface such as virtual interface 252.

Table 1.2 is an example routing table in which the first column contains destination virtual IP addresses 169.254.10.0 to 169.254.10.3 and the second column contains their respective routing paths (IP addresses 169.254.11.0 to 169.254.11.3).

TABLE 1.2
Example Routing Table for Virtual IP address destinations

| Destination Virtual IP Address | Routing Path |
|---|---|
| 169.254.10.0 | 169.254.11.0 |
| 169.254.10.1 | 169.254.11.1 |
| 169.254.10.2 | 169.254.11.2 |
| 169.254.10.3 | 169.254.11.3 |

Packet switch 202 could also comprise an Address Resolution Protocol (ARP) Table. An ARP table could store the correspondence between a network interface's IP address(es) and its Media Access Controller (MAC) address(es).

A MAC address is a unique identifier assigned to a network interface for use as a network address in communications within a network. A MAC address is typically a 48-bit number usually represented as six groups of two-digit hexadecimal numbers separated by colons, dashes or periods. An example MAC address is 00:B0:D0:65:C2:26

The ARP table of packet switch 202 could store the MAC addresses corresponding to the respective routing paths to the virtual IP addresses. The corresponding MAC addresses of the respective routing paths to the virtual IP addresses could all be MAC addresses of the same network interface, such as, for example, virtual interface 252 of host machine 250. Virtual Interface 252 could have multiple MAC addresses assigned to it.

Table 1.3 is an example ARP table in which the first column contains routing paths to virtual IP addresses and the second column contains the routing path's corresponding MAC addresses. For example, the MAC address corresponding to routing path 169.254.11.0 is MAC address 00:B0:D0:65:C2:01. MAC addresses 00:B0:D0:65:C2:01 to 00:B0:D0:65:C2:04 could all be MAC addresses of virtual interface 252 and packets destined for any of IP addresses 169.254.11.0 to 169.254.11.3 could all be sent to virtual interface 252.

Table 1.3 is an example only. The virtual IP and MAC addresses need not be consecutive and an ARP table could contain entries for other IP address of other devices on the network.

TABLE 1.3
Example ARP Table

| IP Address | MAC Address |
|---|---|
| 169.254.11.0 | 00:B0:D0:65:C2:01 |
| 169.254.11.1 | 00:B0:D0:65:C2:02 |
| 169.254.11.2 | 00:B0:D0:65:C2:03 |
| 169.254.11.3 | 00:B0:D0:65:C2:04 |

Packet switch 202 could also comprise a MAC address table. A MAC address table could determine which one of a packet switch's plurality of I/O interfaces a packet should be sent out from to reach a particular MAC address. The MAC address could be the corresponding MAC address of a routing path to a virtual address.

For example, referring to FIG. 2A, which one of input/output interfaces I/O0 . . . I/ON−1 of packet switch 202 to send a packet out from to reach one of the MAC addresses of virtual interface 252 could be stored in a MAC address table of packet switch 202. The MAC addresses could be the corresponding MAC addresses of routing paths to virtual addresses and this correspondence could be stored in the ARP table of packet switch 402.

Table 1.4 is an example MAC address table in which the first column contains MAC addresses and the second column contains their corresponding I/O interface labels. For example, referring to the first row of table 1.4, to reach MAC address 00:B0:D0:65:C2:01 a packet should be sent out from I/O interface I/O0.

TABLE 1.4
Example MAC address table

| MAC Address | I/O interface |
|---|---|
| 00:B0:D0:65:C2:01 | I/O₀ |
| 00:B0:D0:65:C2:02 | I/O₁ |
| 00:B0:D0:65:C2:03 | I/O₂ |
| 00:B0:D0:65:C2:04 | I/O₃ |

Table 1.4 is an example only. A MAC table could contain entries for other MAC addresses of other devices or interfaces on the network.

A packet switch's different I/O interfaces could each be connected to different security application instance to create a one-to-one correspondence between the I/O interfaces and the security application instances. For example, each of I/O0 . . . I/ON−1 could connect to a different one of security application instances 2100 210N−1¬ creating a one-to-one correspondence between each of I/O0 . . . I/ON−1 and security application instances 2100 . . . 210N−1¬. A MAC address table containing these I/O interface labels could then create a one-to-one correspondence between the MAC addresses of a virtual interface and security application instances.

For example, referring to MAC address table 1.4, if I/O interfaces I/O1 to I/O3 have one to one correspondences to security application instances 2100 to 2103 then MAC address table 1.4 could create a one to one correspondence between MAC addresses 00:B0:D0:65:C2:01 to 00:B0:D0:65:C2:04 and security application instances 210¬0 to 2103. MAC addresses 00:B0:D0:65:C2:01 to 00:B0:D0:65:C2:04 could all be MAC addresses for virtual interface 252. Packets and packet flows sent to respective MAC addresses 00:B0:D0:65:C2:01 01 to 00:B0:D0:65:C2:04 by packet switch 402 would pass through and be processed by respective security application instance 2100 to 2103 on their way to virtual interface 232.

Further, an ARP table containing these MAC addresses could then create a one-to-one correspondence between routing paths to virtual IP addresses and security application instances.

For example, referring to ARP address table 1.3, if MAC addresses 00:B0:D0:65:C2:01 to 00:B0:D0:65:C2:04 have one to one correspondences to security application instances 2100 to 2103 then ARP address table 1.3 could create a one to one correspondence between routing path addresses 169.254.11.0 to 169.254.11.3 and security application instances 210¬0 to 2103. Packets and packet flows sent to respective routing paths 169.254.11.0 to 169.254.11.3 would be processed by respective security application instance 2100 to 2103.

Further, a routing table containing these routing paths could then create a one-to-one correspondence between virtual IP addresses and security application instances.

For example, referring to routing table 1.2, if routing paths 169.254.11.0 to 169.254.11.3 have a one-to-one correspondence to security application instances 2100 to 2103 then routing table 1.2 could create one-to-one correspondences between virtual IP addresses 169.254.10.0 to 169.254.10.3 and security application instances 210¬0 to 2103. Packets and packet flows sent to virtual IP addresses 169.254.10.0 to 169.254.10.3 would pass through and be respectively processed by security application instance 2100 to 2103.

Table 1.5 summarizes the correspondence between virtual IP addresses, routing paths, MAC addresses, I/O ports and security application instances.

TABLE 1.5
Example correspondence between virtual IP addresses, routing paths,
MAC addresses, I/O ports and security application instances

| | | | | Security |
|---|---|---|---|---|
| | | | | Applica- |
| Virtual IP | Routing | | I/O | tion |
| Destination | Path | MAC Address | interface | Instance |
| 169.254.10.0 | 169.254.11.0 | 00:B0:D0:65:C2:01 | I/O₀ | 210₀ |
| 169.254.10.1 | 169.254.11.1 | 00:B0:D0:65:C2:02 | I/O₁ | 210₁ |
| 169.254.10.2 | 169.254.11.2 | 00:B0:D0:65:C2:03 | I/O₂ | 210₂ |
| 169.254.10.3 | 169.254.11.3 | 00:B0:D0:65:C2:04 | I/O₃ | 210₃ |

FIG. 2B is a block diagram of a method of load balancing packet flows of a plurality of security application instance using a packet switch.

Method 270 begins at 272. At 272 a packet is received by a packet switch such as packet switch 202.

At 274 a flow key for the packet, symmetric hash value of the flow key and a modulo result of the hash value are determined by the packet switch.

At 276 a virtual IP address for the packet is determined by the packet switch. The virtual IP address could be determined based on the packet's destination network, the packet switch's routing table (such as Table 1.1) and the modulo result. The determination could use the packet switch's ECMP functionality.

At 278 a routing path to the virtual IP address is determined based on the virtual IP address and the packet switch's routing table (such as for example Table 1.2).

At 280 the corresponding MAC address of the routing path to the virtual IP address is determined. The MAC address could be determined by looking up the routing path to the virtual IP address in the packet switch's ARP table, such as, for example Table 1.3. The determined MAC address is the MAC address corresponding to the spare security application instance.

At 282 the one of a plurality of I/O interfaces to send the packet out from to reach the MAC address is determined and the packet is sent out from the one I/O interface. The one interface could be determined by looking up the MAC address in a MAC address table of the packet switch such as Table 1.4.

At 284 the packet is received and processed by the security application instance connected to the one I/O interface, for example one of security application instances 2100 . . . 210N−1 of Load balancer 200.

### Resilient Hashing

In the event of the removal or failure of a security application instance the packet flows with a modulo result corresponding to the removed or failed security application instance could be directed to another security application instance.

This could be done by simply reducing the denominator of the modulo operation. For example, if one security application instances were to fail the modulo denominator could be reduced from N to N−1. However, if the denominator of the modulo operation is simply reduced by the number of failed security application instances, the packet flows of all the remaining active security application instances could be undesirably redistributed.

For example, referring to FIG. 2A, if a packet entering from the EAST side at port 222 of packet switch 202 had a calculated symmetric hash value of 16 and there were N=8 security application instances 2100 . . . 210N−1 then the hash result would be subjected to a modulo 8 operation. The modulo result for 16 MOD 8 is 0 and the packet would be sent to the first security application instance (2100). If security application instance 2107 were removed or failed and the denominator of the modulo operation accordingly reduced from 8 to 7 then the modulo result for a subsequent packet in the same flow would be 2 (16 mod 7) and that packet would be sent to security application instance 2102 instead of security application instance 2100 The redistribution of any remaining packets in the packet's flow from security application instance 2010 to 2012 could have undesirable effect on the packet's flow.

Resilient hashing could be used to distribute packet flows over multiple paths and security application instances in a stateful manner and restrict the redistribution of packet flows to only those flows assigned to a removed or failed security application instance. Resilient hashing is also sometimes referred to as consistent hashing.

In resilient hashing the modulo operation could be based on a denominator greater than the number of paths or security instances. For example, if there were four security application instances the modulo operation could be based on a denominator of value twelve rather than four. Packets could be sent to security application instances based on their modulo result however a range of modulo results could map to the same security application instance.

For example, to distribute packets across the “N” security application instances 2100 . . . 210N−1 of FIG. 2A a modulo operation based on N2 could be used. Packets with modulo results spanning a continuous range of “N” modulo values could be distributed to a single security application instance. For example, packets with modulo results ranging from 0 to N−1 could be sent to the first security application instance. 2100. Packets with modulo results ranging from N to 2N−1 could be sent to the second security application instance, 2101. Packets with modulo results ranging from 2N to 3N−1 could be sent to the third security application instance 2102 and so on. Packets with modulo results ranging from N(N−1) to N2−1 could be sent to the Nth security application instance, 210N−1.

This is an example only and the modulo denominator need not be based on N2. Larger or smaller modulo denominators could be chosen. For example, a modulo denominator of N(N−1) might be chosen.

In the event of removal or failure of a security application instance, the mapping of modulo results to security application instances could be changed. Modulo results that were mapped to the removed or failed instance could be remapped to the remaining active N−1 security application instances. The remapping could attempt to evenly distribute packet flows across the remaining active security application instances. The original mapping of modulo results to the remaining active security application instances would not be changed. Packets and packet flows mapped to the remaining active security application instances would not be redistributed.

Table 2 is an example mapping table using resilient hashing for a modulo denominator of 16 and four security application instances (FW0, FW1, FW2, FW3). The first column of Table 2 is a packet's modulo result. The second column of Table 2 shows the modulo mapping to security application instances with all four security application instances active. Modulo results 0 to 3 are mapped to security application instance FW0. Modulo results 4 to 7 are mapped to security application instance FW1. Modulo results 8 to 11 are mapped to security application instance FW2. Modulo results 12 to 15 are mapped to security application instance FW3.

The third column of Table 2 shows the mapping with one security application instance (FW3) failed or removed. Modulo results 12, 13, 14, 15 are now mapped to security application instances FW0, FW1, FW2 and FW0, respectively and packets with those modulo results are sent to those respective security application instances. The mapping of modulo results from 0 to 11 are unchanged and packets with those modulo results are not redistributed.

When a security application instance recovers or is replaced, resilient hashing could return modulo mapping to the original mapping. Modulo values previously mapped to the failed security application instance could be remapped to the recovered or replacement security application instance.

Column 4 of Table 2 shows an example modulo remapping after the recovery of security application instance FW3. Modulo results 12, 13, 14, 15 are remapped to security application instance FW3 from security application instances FW0, FW1, FW2 and FW0.

TABLE 2
Modulo Result to Security Application Instance Mapping

| | Modulo result mapping | Modulo result | |
|---|---|---|---|
| | with four working | mapping after | Modulo result |
| Modulo | instances (FW0, FW1, | failure of | mapping after |
| result | FW2, FW3) | instance FW3 | recovery of FW3 |
| 0 | FW0 | FW0 | FW0 |
| 1 | FW0 | FW0 | FW0 |
| 2 | FW0 | FW0 | FW0 |
| 3 | FW0 | FW0 | FW0 |
| 4 | FW1 | FW1 | FW1 |
| 5 | FW1 | FW1 | FW1 |
| 6 | FW1 | FW1 | FW1 |
| 7 | FW1 | FW1 | FW1 |
| 8 | FW2 | FW2 | FW2 |
| 9 | FW2 | FW2 | FW2 |
| 10 | FW2 | FW2 | FW2 |
| 11 | FW2 | FW2 | FW2 |
| 12 | FW3 | FW0 | FW3 |
| 13 | FW3 | FW1 | FW3 |
| 14 | FW3 | FW2 | FW3 |
| 15 | FW3 | FW0 | FW3 |

Referring to FIG. 2A, resilient hashing could be a built-in function of packet switch 202 and be performed automatically by the switch on removal or failure of one of security application instances 2100 . . . 210N−1.

### Security Application Instance Monitoring for Failure and Recovery

It could be important to detect the failure or removal of a security application instance. Some packet switches could have built-in monitoring of their interfaces, such as input/output interfaces I/O1 . . . I/ON−1 of packet switch 202 and detect when a packet has been sent to a security application instance but not returned from the security application instance. This type of monitoring might not be ideal. For example, a security application instance might be working normally but not forward a packet to the packet switch if it deems the packet to be malicious.

This type of monitoring might also not be ideal to detect sub-optimal performance of a security application instance. Sub-optimal performance could include, for example, a security application instance not properly performing a security function yet still returning a packet. As another example, a security application instance could fail to update its security policies and continue to operate with outdated security policies while still receiving and returning packets.

Referring to FIG. 2A, monitoring agent 204 could monitor the state of security application instances 2100 . . . 210N−1 by periodically sending them monitoring packets. Monitoring packets could be sent to all of security application instances 2100 . . . 210N−1 via monitor port 226 of packet switch 202. Packet switch 202 could send the monitoring packets to input/output interfaces I/O0-I/ON−1. After processing by security application instances 2100 . . . 210N−1, unless they are being dropped, the returned monitoring packets could return to packet switch 202 on input/output interfaces I/O0-I/ON−1. Packet switch 202 could send the returned packets to monitoring agent 204 via monitor port 226. Monitoring packets could be sent using a standard network fault detection protocol, such as, for example, the Bidirectional Forwarding Protocol (BFD). The BFD protocol could provide fast and low overhead fault detection

Failure of a monitoring packet to return to monitoring agent 204 could indicate the failure or removal of the security application instance it was sent to. In one embodiment, three successive non-returned packets could result in a determination by the monitoring agent that a security application instance has failed. This is just an example and a fewer or greater number of non-returned packets could result in a determination by the monitoring agent that a security application instance has failed.

Monitoring packets could be designed to test the security policies of the security application instance. Failure of a security application instance to properly process a packet could indicate a failed security instance.

Recovery of a failed security application instance might also be detected by a monitoring agent such as monitoring agent 204 of FIG. 2A. Monitoring agent 204 could send monitoring packets to a failed security application instance (one of security application instances 2100 . . . 210N−1) via monitor port 226 and input/output interfaces I/O1 . . . I/ON−1 of packet switch 202. If the failed security application instance had recovered it could send a return packet back to the monitoring agent. A number of returned packets could indicate that a security application instance has recovered and is ready to be put back into service.

Other ways of monitoring the status of security application instances are possible. For example, a monitoring agent might directly monitor the status of each security application instance by interrogating a security application instance through the packet switches' Application Programming Interface (API). For example, monitoring agent 204 might interrogate security application instances 2100 . . . 210N−1 through API 230 of packet switch 202. A monitoring agent might also or instead directly interrogate a security application instance through the security application instances' own API (not shown).

The monitoring agent might interrogate a security application instance as to its reported health. It might for example, verify that a previously failed or replacement security application instance has properly synchronized with the other security application instances in the cluster. It might, for example verify that the security application instance has an up-to-date list of security policies. This could be an improvement over just monitoring for returned packets. For example, a security application instance might reboot and begin processing and forwarding packets before it has synchronized with the security application instance cluster.

The monitoring agent might also or instead interrogate the active security application instances to verify that the previously failed security application instance is healthy. For example, the monitoring agent might interrogate the active security application instances to verify that they are in communication with the previously failed security application instance. As another example, the monitoring agent might interrogate the active security application instances to verify that they have successfully synchronized with the previously failed security application instance.

### Security Application Instance Failure

On detection of the failure or removal of a security application instance a monitoring agent could configure a packet switch to no longer send packets or packet flows to the failed or removed security application instance. For example, referring to FIG. 2A, monitoring agent 204 could configure packet switch 202 through API 230 to no longer send packets to security application instance 2100 if security application instance 2100 was determined to have failed or been removed.

Monitoring agent 204 could configure packet switch 202 to no longer send packets to a failed security instance by editing its routing table. Monitoring agent 204 could remove the routing path for the virtual IP address corresponding to the failed or removed security application instance.

For example, referring to Table 1.2, virtual IP address 169.254.10.0 could correspond to security application instance 2100. On detecting a failure of security application instance 2100, monitoring agent 204 could edit table 1.2 and remove the routing path (169.254.11.0) to the virtual IP address 169.254.10.0. The edit of the routing table could be detected by the packet switch and it could implement resilient hashing.

Packet switch 202 could determine that virtual IP address 169.254.10.0 was no longer reachable as the routing path to it was removed. Packet switch 202 could then use resilient hashing to distribute subsequent packets and packet flows with a modulo result that originally mapped to failed security application instance 2100 to remaining security application instances 2101 . . . 210N−1 while not redistributing packets and packets flows with modulo results corresponding to the remaining active security application instances.

A monitoring agent such as monitoring agent 204 could edit the routing table of a packet switch such as packet switch 202 using a standard network communications protocol, such as, for example, the Border Gate Protocol (BGP).

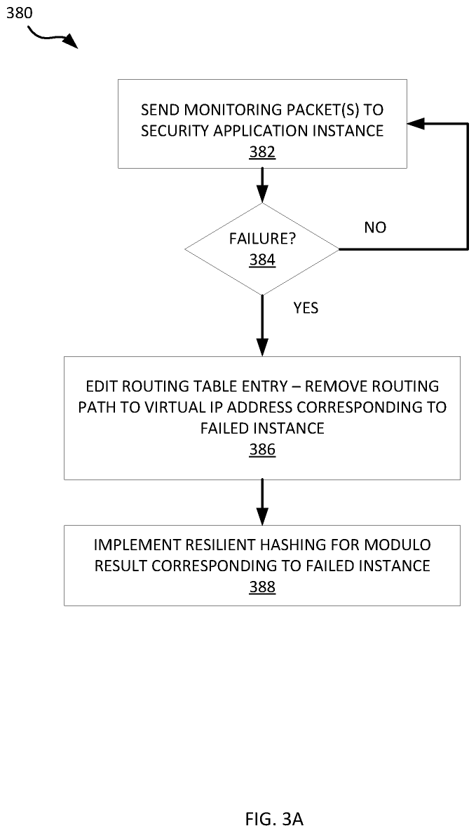

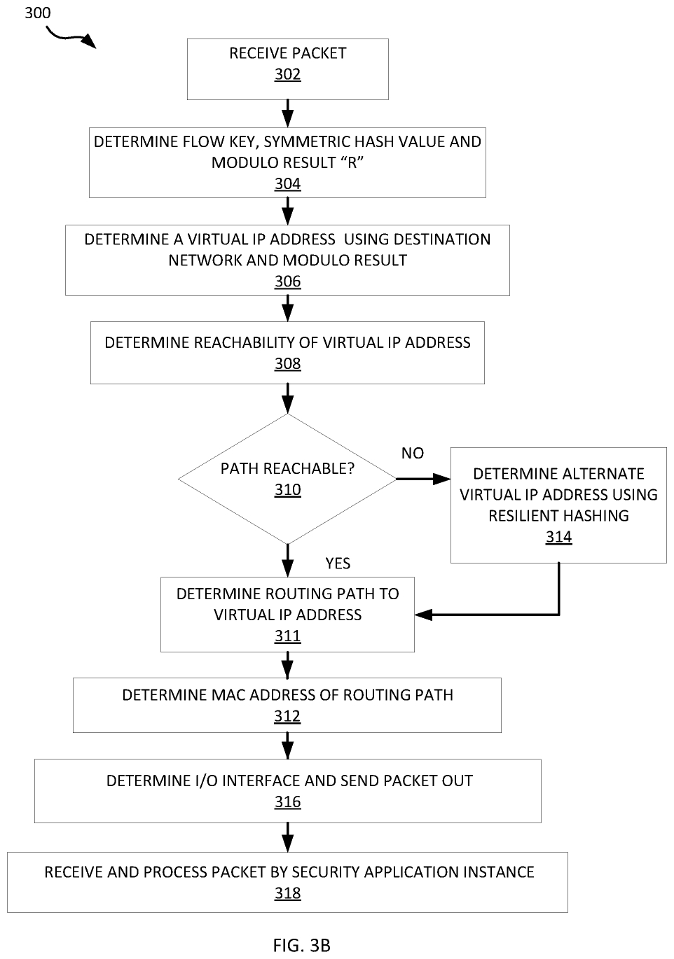

FIG. 3A is a flow diagram of an example method of handling a failed security application instance in a load balancer using a packet switch. Method 380 begins at 382.

At 382 a monitoring packet(s) are sent to a security application instance by a monitoring agent. At 384 the monitoring agent, based on the monitoring packet(s), determines if the security application instance has failed. If the security application instance is determined not to have failed (NO at 304) then an additional monitoring packet(s) are again sent at 382. If the security application instance is determined to have failed (YES at 304) then at 386 the routing table of the packet switch is edited to remove the routing path to the virtual IP address corresponding to the failed security application. At 388 the withdrawal of the routing path to the virtual IP address is detected by the packet switch and the packet switch implements resilient hashing for modulo results corresponding to the failed security application instance.

FIG. 3B is a flow diagram of a load balancing method. Method 300 begins at 302.

At 302 a packet is received by, for example a packet switch such as packet switch 202.

At 304 a flow key for the packet, a symmetric hash value of the flow key and a modulo result of the hash value are determined by the packet switch.

At 306 a virtual IP address for the packet is determined by the packet switch based on the packet's destination network and its modulo result. The virtual IP address could be determined based on the packet's destination network the packet switch's routing table (such as Table 1.1 of packet switch 202) and the modulo result.

At 308 the packet switch determines if the virtual IP address is reachable. Reachability could be determined by the packet switch on an edit to its routing table by a monitoring agent such as monitoring agent 204. Reachability could also be determined by looking up the virtual IP address in the packet switch's routing table (such as Table 1.1 of packet switch 202). A reachable virtual IP address has an entry in the routing table and a corresponding routing path. A virtual IP address that is not reachable will not have an entry in the routing table.

If the virtual IP address is reachable (YES at 310) then at 311 the routing path to the virtual IP address is determined. The routing path could be determined from the virtual IP address's routing path entry in the routing table.

At 312 the MAC address of the routing path to the virtual IP address is determined. The MAC address could be determined by looking up the routing path to the virtual IP address in the packet switch's ARP table, such as, for example Table 1.3 of packet switch 202.

At 316 one of a plurality of I/O interfaces to send the packet out from to reach the MAC address is determined and the packet is sent out from the one I/O interface. The interface number could be determined by looking up the MAC address in a MAC address table of the packet switch such as, for example, table 1.4 of packet switch 202.

At 318 the packet is received and processed by the security application instance connected to the one I/O interface, for example one of security application instances 2100 . . . 210N−1 of Load balancer 200.

If the virtual IP address is not reachable (NO at 310) then an alternate virtual IP address for the packet is determined at 314 using resilient hashing. The alternate virtual IP address could correspond to a remaining active security application instance.

At 311 the routing path to the alternate virtual IP address is determined. The routing path could be determined from the alternate virtual IP address's entry in the packet switch's routing table.

At 312 the MAC address of the routing path to the alternate virtual IP address is determined. The MAC address could be determined by looking up the routing path of the alternate virtual IP address in the packet switch's ARP table, such as, for example Table 1.3 of packet switch 202.

At 316 one of a plurality of I/O interfaces to send the packet out from to reach the MAC address is determined and the packet is sent out from the one I/O interface. The interface number could be determined by looking up the MAC address in a MAC address table of the packet switch such as, for example, table 1.4 of packet switch 202.

### Hot Spare Security Application Instance

It is possible that multiple security application instances in a security application instance cluster could fail or be removed from operation. A spare security application instance could beneficially improve the operation of a security application instance cluster by providing the ability to replace a failed security application instance with the spare instance.

FIG. 4 is a block diagram of another security control point implementation. Security control point 400 comprises packet switch 402 and host machines 450 and 460.

Host machines 450 and 460 could be general purpose computing hardware such as servers.

Host machine 450 hosts security application cluster 410 and virtual interface 252.

Security application cluster 410 comprises security application instances 4100 . . . 410N. Security applications instances 4100 . . . 410N could run on virtual machines as described previously and be instances of any of one of the types of security applications described previously.

Security application instance 410N could be a spare security application instance and not process packet flows entering security control point 400 when all of security application instances 4100 . . . 410N−1 are operating normally.

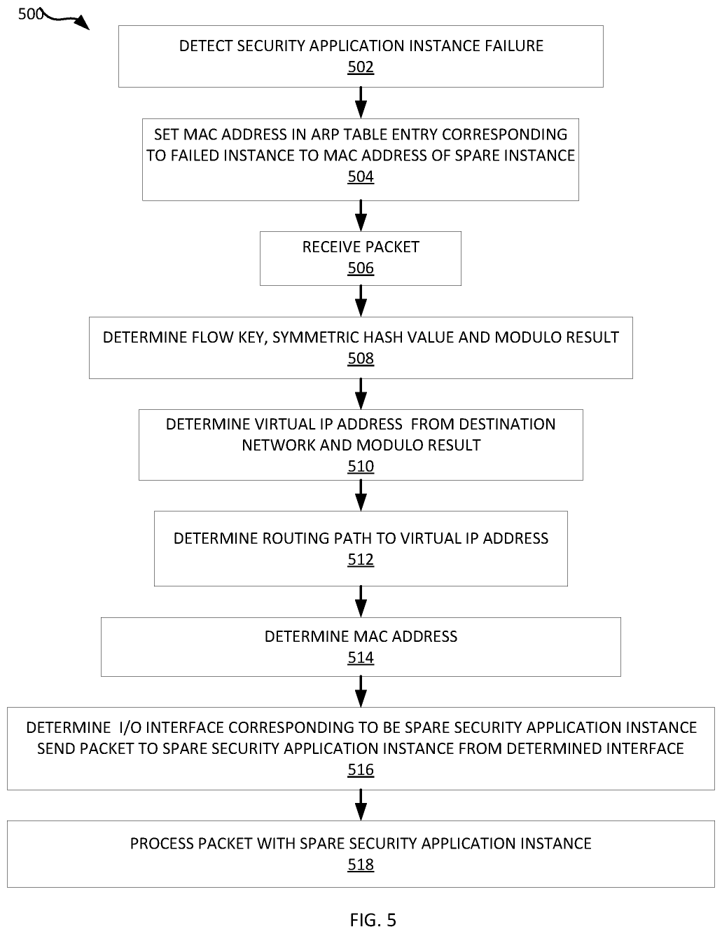

Virtual interface 452 receives packets processed by any of security application instances 4100 . . . 410N and forwards them back to packet switch 402. For simplicity the return path is not shown in FIG. 5. A virtual interface is an abstract or virtualized representation of a network interface. A virtual interface could allow more than network interface on a single physical interface or connection. A virtual interface could also combine two physical interfaces together. Virtual interfaces provide many of the same features as physical interfaces.

Host machine 460 hosts monitoring agent 404. Monitoring agent 404 could be a software application and monitor and control the behavior of packet switch 402 and/or security applications instances 4100 . . . 410N.

Packet switch 402 comprises a plurality of bidirectional input/output interfaces I/O0 . . . I/ON, monitor interface 226, bi-directional interfaces 422, 424 and Application Programming Interface (API) 430.

Packet switch 402 could be a general-purpose packet switch and I/O interfaces I/O0 . . . I/ON could be general purpose input/output interfaces. Packet switch 402 could be capable of switching packets received at any one of interfaces I/O0 . . . I/ON, 422 and 424 to any other interface. Although packet switch 402 is described as a “switch” this term is used generically to describe its action of switching a packet received at one of its interfaces to another of its interfaces.

Packet switch 402 could be a generic off the shelf device such as for example the Cisco NEXUS 9364C Ethernet switch or the Juniper Networks QFX5130 Ethernet switch.

Packet switch 402 could also comprise an Application Specific Integrated Circuit (ASIC) (not shown).

Packet switch 402 connects to security application instances 4100 . . . 410N through respective input/output interfaces I/O0 . . . I/ON. Input/output interfaces I/O0 . . . I/ON could be physical interfaces or virtual interfaces. Virtual interfaces could be enabled by a variety of protocols, including, for example, Virtual Routing and Forwarding (VRF) or Virtual Local Area Network (VLAN) tags. There is a one-to-one correspondence between input/output interfaces I/O1 . . . I/ON−1 and security application instances 4100 . . . 410N.

Spare security application instance 410N might not process packet flows entering packet switch 402 from interface 422 or 424 when all of security application instances 4100 . . . 410N−1 are operating normally. Spare security application instance 410N could process packet flows entering packet switch 402 from interface 422 or 424 if any of security application instances 4100 . . . 410N−1 were to fail.

FIG. 4 is an example only and other configurations are possible. For example, rather than security application instance 410N, any one of security application instances 4100 . . . 410N could be the spare security application instance. The monitoring agent could be hosted on the same host machine as the security application instances rather than on its own host machine 460. For example, monitoring agent 404 could be hosted with security application instances 4100 . . . 410N on host machine 450 and there might be no separate host 460.

It could, however, be beneficial for a monitoring agent such as monitoring agent 404 to be hosted on a separate host machine from the security application instances, such as security application instances 4100 . . . 410N. If for example, host machine 450 were to become unstable, monitoring agent 404 could be unaffected and could detect and signal the instability or failure of host 450 and/or security application instances 4100 . . . 410N.

Security application cluster 410 could instead of being hosted on a single host machine be hosted across multiple host machines.

Interfaces 424 and 424 could be single interfaces or a group of interfaces.

Further variations on the security control point arrangement of FIG. 4 are also possible. The security application instances could be security hardware appliances rather than hosted software instances. For example, there could be no host 450 and security instances 4100 . . . 410N could be hardware instances. Hardware instances could be dedicated security appliances such as for example, one of the Fortinet 600F series of security appliances manufactured by Fortinet of Sunnyvale California. The hardware instances could perform similar security functions as those described for software instances 4100 . . . 410N.

Packets traveling in the EAST to WEST direction are received at interface 422 of packet switch 402. Packets traveling in the WEST to EAST direction are received at interface 424 of packet switch 402.

Packet switch 402 could forward a packet received at one of interfaces 422 and 424 to one of security application instances 4100 . . . 410N−1 through one of input/output interfaces I/O0 . . . I/ON−1. Packet switch 402 could be configured to distribute received packet flows between security application instances 4100 . . . 410N−1 as evenly as possible. This is often referred to as load balancing.

Packet switch 402 could have built-in Equal Cost Multi-Path (ECMP) functionality and load balance traffic across security application instances 4100 . . . 410N−1 using this functionality. ECMP is a packet flow routing strategy where packet flows for a single destination can be sent over multiple paths with equal routing priority. All packets in a particular flow take the same path.

Packet switch 402 could direct a packet to one of input/output interfaces I/O0 . . . I/ON−1 in a stateful manner using directionally symmetric hashing of the packet's flow key and a modulo operation on the hash value to produce a modulo result as described previously. The symmetric hashing and modulo operation could provide for stateful load balancing of bi-directional packet flows as described previously. The hashing, modulo operation and distribution of packets to the switch's input/output interfaces could be done using the packet switch's built in ECMP functionality.

Similar to packet switch 202 of security point 200, some of the ECMP functionality of packet switch 402 could be configured by monitoring agent 404. Packet switch 402 could comprise a routing table (not shown).

Monitoring agent 404 could create a plurality of routing paths to a particular destination network. It could create a routing path corresponding to each of security application instances 4100 . . . 410N−1 and intended to send packet flows through each of security application instances 4100 . . . 410N−1. For example, monitoring agent 404 could create N possible routing paths in the routing table of packet switch 402 corresponding to respective security application instances 4100 . . . 410N−1. Packet switch 402 could determine which particular routing path of the plurality of routing paths to send a packet flow to using its built-in ECMP functionality.

There might not be any routing path in the routing table corresponding to a spare security application such as spare security application 410N.

Monitoring agent 404 could create routing paths using virtual IP addresses. A virtual IP address is an address that does not correspond to an actual network device (physical or virtual). For example, referring to FIG. 4, the respective routing paths corresponding to security application instances 4100 . . . 410N−1 could be the virtual IP addresses from 169.254.10.0 to 169.254.10.N−1 and these addresses would not be the actual IP addresses of security application instances 4100 . . . 410N−1 or of any other devices (physical or virtual) on the local network. There might not be any virtual IP address in the routing table corresponding to spare security application 410N.

Table 3.1 is an example routing table in which the destination address (the internet) has four virtual IP address routing paths. The four possible routing paths are virtual IP addresses 169.254.10.0 to 169.254.10.3. Table 3.2.1 shows the correspondence between the routing paths 169.254.10.0 to 169.254.10.3 and security application instances 4100 . . . 4103.

TABLE 3.1
Example Routing Table

| Destination | Virtual IP Routing Path |
|---|---|
| Internet | 169.254.10.0 |
| | 169.254.10.1 |
| | 169.254.10.2 |
| | 169.254.10.3 |

Table 3.1 is an example only and the virtual IP addresses need not be consecutive and the routing table could contain additional entries for other destinations.

TABLE 3.2.1
Routing path to Security Application Instance correspondence

| | Corresponding Security |
|---|---|
| Virtual IP Routing Path | Application Instance |
| 169.254.10.0 | 410₀ |
| 169.254.10.1 | 410₁ |
| 169.254.10.2 | 410₂ |
| 169.254.10.3 | 410₃ |

A routing table could further include entries for respective routing paths to the respective virtual IP addresses. These respective routing paths might be the IP addresses of an interface such as virtual interface 452. For example, the respective routing paths to virtual IP addresses 169.254.10.0 to 169.254.10.N−1 could be the IP addresses 169.254.11.0 to 169.254.11.N−1 and IP addresses 169.254.11.0 to 169.254.11.N−1 could be IP addresses of an interface such as virtual interface 452.

Table 3.2.2 is an example routing table in which the first column contains destination virtual IP addresses 169.254.10.0 to 169.254.10.4 and the second column contains their respective routing paths (IP addresses 169.254.11.0 to 169.254.11.4).

TABLE 3.2.2
Example Routing Table for Virtual IP address destinations

| Destination Virtual IP Address | Routing Path |
|---|---|
| 169.254.10.0 | 169.254.11.0 |
| 169.254.10.1 | 169.254.11.1 |
| 169.254.10.2 | 169.254.11.2 |
| 169.254.10.3 | 169.254.11.3 |

Packet switch 402 could also comprise an Address Resolution Protocol (ARP) Table. An ARP table could store the correspondence between a network interface's IP address and its Media Access Controller (MAC) address.

The ARP table of packet switch 402 could store the corresponding MAC addresses of the respective routing paths to the virtual IP addresses. The corresponding MAC addresses of the respective routing paths to the virtual IP addresses could all be MAC addresses of the same network interface such as, for example, virtual interface 452 of host machine 410. Virtual Interface 452 could have multiple MAC addresses assigned to it.

Table 3.2.3 is an example ARP table in which the first column contains routing paths to virtual IP addresses and the second column contains the routing path's corresponding MAC addresses. For example, the MAC address corresponding to routing path 169.254.11.0 is MAC address 00:B0:D0:65:C2:01. MAC addresses 00:B0:D0:65:C2:01 to 00:B0:D0:65:C2:04 could all be MAC addresses of virtual interface 452 and packets destined for any of IP addresses 169.254.11.0 to 169.254.11.3 could all be sent to virtual interface 452.

TABLE 3.2.3
Example ARP Table

| IP Address | MAC Address |
|---|---|
| 169.254.11.0 | 00:B0:D0:65:C2:01 |
| 169.254.11.1 | 00:B0:D0:65:C2:02 |
| 169.254.11.2 | 00:B0:D0:65:C2:03 |
| 169.254.11.3 | 00:B0:D0:65:C2:04 |

Packet switch 402 could also comprise a MAC address table. A MAC address table could determine which one of a packet switch's plurality of I/O interfaces a packet should be sent out from to reach a particular MAC address. The MAC address could correspond to a routing path to a virtual address.

Table 3.2.3 is an example only. The virtual IP and MAC addresses need not be consecutive and an ARP table could contain entries for other IP address of other devices on the network.

Packet switch 402 could also comprise a MAC address table. A MAC address table could determine which one of a packet switch's plurality of I/O interfaces a packet should be sent out from to reach a particular MAC address. The MAC address could be the corresponding MAC address of a routing path to a virtual address.

For example, referring to FIG. 4, which one of input/output interfaces I/O0 . . . I/ON of packet switch 402 to send a packet out from to reach one of the MAC addresses of virtual interface 452 could be stored in a MAC address table of packet switch 402. The MAC addresses could be the corresponding MAC addresses of routing paths to virtual addresses and this correspondence could be stored in the ARP table of packet switch 402.

Table 3.2.4 is an example MAC address table in which the first column contains MAC addresses and the second column contains their corresponding I/O interface labels. For example, referring to the first row of table 1.4, to reach MAC address 00:B0:D0:65:C2:01 a packet should be sent out from I/O interface I/O0.

TABLE 3.2.4
Example MAC address table

| MAC Address | I/O interface |
|---|---|
| 00:B0:D0:65:C2:01 | I/O₀ |
| 00:B0:D0:65:C2:02 | I/O₁ |
| 00:B0:D0:65:C2:03 | I/O₂ |
| 00:B0:D0:65:C2:04 | I/O₃ |
| 00:B0:D0:65:C2:05 | I/O₄ |

Table 3.2.4 is an example only. A MAC table could contain entries for other MAC addresses of other devices or interfaces on the network.

As previously described for security control point 200, a one-to-one correspondence between security application instances and the MAC addresses of virtual interface 452 could be created using a MAC address table. A packet switch's different I/O interfaces could each be connected to different security application instances to create one-to-one correspondences between I/O interfaces and security application instances. For example, each of I/O1 . . . I/ON could connect to a different one of security application instances 4100 . . . 410N¬ creating a one-to-one correspondence between each of I/O1 . . . I/ON and security application instances 4100 . . . 410N¬. A MAC address table containing these I/O interface labels could then create a one-to-one correspondence between the MAC addresses of a virtual interface and security application instances.

For example, referring to MAC address table 3.2.4, if I/O interfaces I/O0 to I/O3 have one to one correspondences to security application instances 4100 to 4103 then MAC address Table 3.2.4 could create a one to one correspondence between MAC addresses 00:B0:D0:65:C2:01 to 00:B0:D0:65:C2: 04 and security application instances 410¬0 to 4103. MAC addresses 00:B0:D0:65:C2:01 to 00:B0:D0:65:C2:04 could all be MAC addresses for virtual interface 452. Packets and packet flows sent to respective MAC addresses 00:B0:D0:65:C2:01 to 00:B0:D0:65:C2:04 by packet switch 402 would pass through and be processed by respective security application instance 4100 to 4103 on their way to virtual interface 452.

An ARP table containing these MAC addresses could then create a one-to-one correspondence between routing paths to virtual IP addresses and security application instances.

For example, referring to ARP address table 3.4, if MAC addresses 00:B0:D0:65:C2:01 to 00:B0:D0:65:C2:04 have one to one correspondences to security application instances 4100 to 4103 then ARP address Table 3.2.3 could create a one to one correspondence between routing path addresses 169.254.11.0 to 169.254.11.3 and security application instances 410¬0 to 4103. Packets and packet flows sent to respective routing paths 169.254.11.0 to 169.254.11.3 would be processed by respective security application instance 4100 to 4103.

Further, a routing table containing these routing paths could then create a one-to-one correspondence between virtual IP addresses and security application instances.

For example, referring to routing table 3.2.2, if routing paths 169.254.11.0 to 169.254.11.3 have a one-to-one correspondence to security application instances 2100 to 2103 then routing table 3.2.2 could create one-to-one correspondences between virtual IP addresses 169.254.10.0 to 169.254.10.3 and security application instances 410¬0 to 4103. Packets and packet flows sent to respective virtual IP addresses 169.254.10.0 to 169.254.10.3 would pass through and be respectively processed by security application instance 4100 to 4103.

A MAC address table of a packet switch such as packet switch 402 could contain an entry with the MAC address corresponding to a spare security application instance. For example, referring to the bottom row of table 3.2.4, the interface labeled I/O4 could connect to a spare security application instance (such as security application 410N of FIG. 4) and the corresponding MAC address 00:B0:D0:65:C2:05 could then correspond to spare security application instance 410N.

The virtual interface could periodically broadcast the MAC address corresponding to the spare security application instance to update the MAC address table of the packet switch with its interface label using the Gratuitous Address Resolution Protocol (GARP).

A spare security application instance could normally be active and running (“hot”) but not receive or process packet flows entering the security control point when the other security application instances are operating normally. For example, referring to FIG. 4, spare security application instance 410N might not process packet flows received at interfaces 422 or 424 of packet switch 402 when security application instances 4100 . . . 410N−1 are operating normally. A spare security application instance could however, receive all the security policies and policy updates that the other security application instances in the cluster receive.

In the event of a failure or removal of a security application instances in a security application cluster, for example, one of security application instances 4100 . . . 410N−1 of security application cluster 410, the failed or removed security application instance could be replaced by a spare security application instance, for example spare security application 410N.

Packet flows with a modulo result mapping to a removed or failed security application instance could be sent to the hot spare security application instance by the packet switch. For example, if security application instance 4100 were to fail, packet flows which would normally be sent to security application instance 4100 could be sent to security application instance 410N. This could be done without editing the routing table of the packet switch or changing the modulo result mapping.

Packet flows could be directed to a spare security application instance by editing the ARP table of a packet switch. The MAC address in the ARP table entry corresponding to the failed security application instance could be changed to the MAC address corresponding to the spare security application instance. This ARP table edit could be done by monitoring agent 404 on detection of a security application instance failure.

For example, referring to the first row of ARP Table 3.4, if MAC address 00:B0:D0:65:C2:01 is the MAC address corresponding to a failed security application instance (for example security application instance 4100), then it could be replaced by the MAC address corresponding to the spare security application instance (00:B0:D0:65:C2:05 for example).

FIG. 5 is a flow diagram of a load balancing method using a packet switch and a hot spare security application instance.

Method 500 begins at 502. At 502 a security application instance failure is detected. A failure could be detected by monitoring agent such as monitoring agent 404 of security control point 400.

At 504 the MAC address in the ARP table of the packet switch corresponding to the failed security application instance is set to the MAC address corresponding to the spare security application instance, such as, for example, security application instance 410N. The MAC address change could be performed by a monitoring agent such as monitoring agent 404.

At 506 a packet is received by the packet switch.

At 508 the flow key for the packet, symmetric hash value of the flow key and a modulo result of the hash value are determined by the packet switch.

At 510 a virtual IP address for the packet is determined by the packet switch. The virtual IP address could be determined based on the packet's destination network, the packet switch's routing table (such as Table 3.1) and the modulo result. The determination could use the packet switch's ECMP functionality.

At 512 a routing path to the virtual IP address is determined based on the virtual IP address and the packet switch's routing table (such as for example Table 3.2.2). The determined routing path is the IP address corresponding to the failed or removed security application instance detected at 502.

At 514 the corresponding MAC address of the routing path to the virtual IP address is determined. The MAC address could be determined by looking up the routing path to the virtual IP address in the packet switch's ARP table, such as, for example table 3.2.3. The determined MAC address is the MAC address corresponding to the spare security application instance rather than the MAC address corresponding to the failed security application instance since the ARP address table was previously edited at 504.

At 516 the one of a plurality of I/O interfaces to send the packet out from to reach the MAC address is determined and the packet is sent out from the one I/O interface. The one interface is determined to be the interface corresponding to the spare security application instance. The one could be determined by looking up the MAC address in a MAC address table of the packet switch such as Table 3.2.4.

At 518 the packet is processed by the spare security application instance.

### Second Failure

On detection of a second failure or removal of a security application instance in a cluster, a monitoring agent could configure a packet switch to no longer send packets or packet flows to the second failed or removed security application instance.

For example, monitoring agent 404 could configure packet switch 402 through API 430 to no longer send packets to security application instance 4101 after the detection of the failure or removal of security application instance 4011 and following the earlier failure or removal of a first security application instance, for example security application instance 4100.

Monitoring agent 404 could configure packet switch 402 to no longer send packets to the second failed or removed security instance by editing its routing table. Monitoring agent 404 could remove the routing path for the virtual IP address corresponding to the failed or removed security application instance.

For example, referring to Table 3.2.1, virtual IP address 169.254.10.1 could correspond to security application instance 4101. On detecting a failure or removal of security application instance 4101 and following the failure or removal of a first security application instance, for example, security application instance 4100, monitoring agent 404 could edit routing table 3.2.2 of packet switch 402 and remove the routing path (169.254.11.1) to the virtual IP address 169.254.10.1. The edit of the routing table could be detected by the packet switch and it could cause it to implement resilient hashing of packets and packet flows.

Packet switch 402 could determine that virtual IP address 169.254.10.1 was no longer reachable as the routing path to it was removed. Packet switch 402 could then use resilient hashing to distribute subsequent packets and packet flows with a modulo result that originally mapped to second failed security application instance 4101 to the remaining security application instances 4102 . . . 410N−1 and spare security application instance 410N while not redistributing packets and packets flows with modulo results corresponding to remaining active security application instances.

A monitoring agent such as monitoring agent 404 could edit the routing table of a packet switch such as packet switch 402 using a standard network communications protocol, such as, for example, the Border Gate Protocol (BGP).

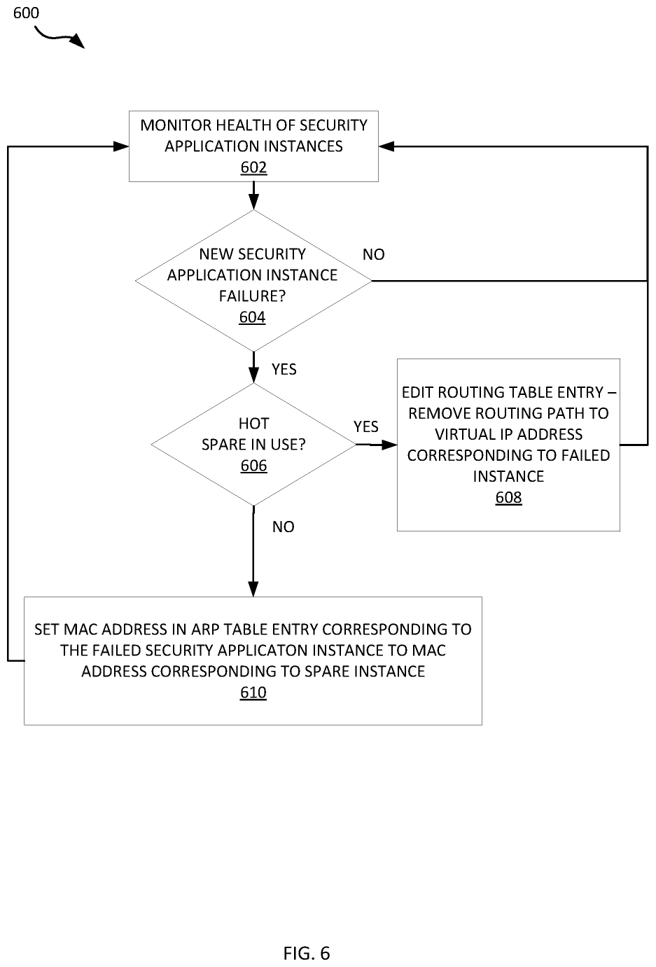

FIG. 6 is a flow diagram of a method of handling the failure of multiple security application instances in a security application instance cluster having a spare security application instance.

Method 600 begins at 602. At 602 the health of a plurality of security application instances such as security application instances 4100 . . . 410N−1 is monitored. The health of the security application instances could be monitored by a monitoring agent such as monitoring agent 404 by the methods discussed previously. At 606 it is determined if there is a new security application instances failure. If there are no new security application instance failure (NO at 604) then then the health of the security application instances is again monitored at 602.

If there is a new security application instance failure (YES at 604) then at 606 it is determined if the hot spare security application instance, for example security application instance 404N of security control point 400, is in use.

If the hot spare security application instance is not in use (NO at 606) then at 610 the ARP table entry corresponding to the failed security application instance is edited. The MAC address in the ARP table entry corresponding to the failed security application instance is changed to the MAC address corresponding to the spare security application instance.

If the spare security application instance is in use (YES at 606) then at 608 the IP address of the failed security application instance is removed as a routing path from the routing table as described previously.

### Recovery After Successive Failures

After the failure of a security application instance, its replacement by a spare security application instance and the failure of another security application instance, one of the failed security application instances could recover or be replaced with a newly created security application instance.

For example, referring to FIG. 4, security application instance 4100 could have failed and been replaced by spare security application instance 410N followed by the failure of security application instance 4101. Subsequently security application instance 4100 could recover or be replaced with a newly created security application instance (for simplicity the newly created instance will also be referred to as security application instance 4100).

On the initial failure of a security application instance, packets and packets flows which would have originally been sent to that security application instance could be sent to a hot spare security application instance.

On the second failure of a security application instance, packets and packet flows which would have originally been sent to that second failed security application instance would then be redistributed over the remaining working security applications using resilient hashing.

The recovery or replacement of a security application instance could be detected by a monitoring agent. All the packet flows with a modulo result corresponding to the most recently failed security application instance could be redirected from the remaining active security application instances and sent to the recovered or replacement security application instance.

For example, if security application instances 4100 and 4101 had both failed, with 4101 being the most recently failed instance, and instance 4100 were to recover or be replaced with a newly created security application instance then packets and packet flows which would originally have been sent to security application 4101 could be sent to the newly recovered or created security application instance 4100.

A monitoring agent could remap a modulo results to security application instance mapping by editing the routing table of a packet switch. For example, referring to FIG. 4, monitoring agent 404 could edit the routing table of packet switch 402 to alter the modulo results to security application instance mapping for security application instances 4100 . . . 410N.

Monitoring agent 404 could edit the routing table of packet switch 402 through API 430 and add a routing path to the virtual IP address previously associated with the most recently failed or removed security application instance. The routing path added could correspond to the recently recovered security application instance or its replacement.

Tables 3.3.1 to 3.3.5 illustrate an example failure and recovery sequence for a security control point such as security control point 400 of FIG. 4 having 5 security application instances (4100 to 4103 and a spare instance 4104).

Table 3.3.1 illustrates the correspondence between virtual IP addresses, routing paths to the virtual IP addresses, MAC Addresses, I/O interface labels and security application instances of the security control point with all security applications operational (including hot spare instance 4104). Virtual IP addresses 169.254.10.0 to 169.254.10.3 correspond one-to-one to respective routing paths 169.254.11.0 to 169.254.11.3, which in turn correspond one-to-one to MAC addresses 00:B0:D0:65:C2:01 to 00:B0:D0:65:C2:04, which in-turn correspond one-to-one to I/O interface labels I/O1 to I/O3, which in-turn correspond one-to-one to respective security application instances 4100 to 4103. Packets and packet flows sent to respective virtual IP addresses 169.254.10.0 to 169.254.10.3 are processed by security application instances 4100 to 4103, respectively. Hot spare security application instance 4104 has a corresponding MAC address (00:B0:D0:65:C2:05) and I/O interface label (I/O4) does not have a corresponding virtual IP address or routing path to the virtual IP address.

TABLE 3.3.1
Example correspondence between virtual IP addresses,
routing paths, MAC addresses, I/O ports and security
application instances in normal operation

| | | | | Security |
|---|---|---|---|---|
| | | | | Applica- |
| Virtual IP | | | I/O | tion |
| Destination | Routing Path | MAC Address | interface | Instance |
| 169.254.10.0 | 169.254.11.0 | 00:B0:D0:65:C2:01 | I/O₀ | 410₀ |
| 169.254.10.1 | 169.254.11.1 | 00:B0:D0:65:C2:02 | I/O₁ | 410₁ |
| 169.254.10.2 | 169.254.11.2 | 00:B0:D0:65:C2:03 | I/O₂ | 410₂ |
| 169.254.10.3 | 169.254.11.3 | 00:B0:D0:65:C2:04 | I/O₃ | 410₃ |
| NA | NA | 00:B0:D0:65:C2:05 | I/O₄ | 410₄ |

Table 3.3.2 illustrate the correspondence between virtual IP addresses, routing paths to the virtual IP addresses, MAC Addresses, I/O interface labels and security application instances of the security control point after the failure of security application instance 4100.

The MAC address corresponding to routing path 169.254.11.0 and previously corresponding to failed instance 4100 (00:B0:D0:65:C2:01) has been set to the MAC address corresponding to hot spare security application instance 4104 (00:B0:D0:65:C2:05). This could be done by editing the ARP table of a packet switch such as packet switch 402 of FIG. 4 as discussed previously. Packets and packet flows sent to virtual address 169.254.10.0 are now processed by hot spare security application instances 4104. Security application 4100 no longer has a corresponding virtual address or routing path.

TABLE 3.3.2
Example correspondence between virtual IP addresses, routing
paths, MAC addresses, I/O ports and security application instances
after failure of security application instance 410₀

| | | | | Security |
|---|---|---|---|---|
| | | | | Applica- |
| Virtual IP | | | I/O | tion |
| Destination | Routing Path | MAC Address | interface | Instance |
| 169.254.10.0 | 169.254.11.0 | 00:B0:D0:65:C2:05 | I/O₄ | 410₄ |
| 169.254.10.1 | 169.254.11.1 | 00:B0:D0:65:C2:02 | I/O₁ | 410₁ |
| 169.254.10.2 | 169.254.11.2 | 00:B0:D0:65:C2:03 | I/O₂ | 410₂ |
| 169.254.10.3 | 169.254.11.3 | 00:B0:D0:65:C2:04 | I/O₃ | 410₃ |
| NA | NA | 00:B0:D0:65:C2:01 | I/O₀ | 410₀ |

Table 3.3.3 illustrate the correspondence between virtual IP addresses, routing paths to the virtual IP addresses, MAC Addresses, I/O interface labels and security application instances of the security control point after the additional failure of security application instance 4101.

The routing path to the virtual IP address previously corresponding to instance 4101 (169.254.10.1) has been removed and the virtual IP address no longer has a corresponding routing path and is unreachable. This could be done by editing the routing table of a packet switch such as packet switch 402 of FIG. 4 as discussed previously.

Packet switch 402 could sense that virtual IP address 169.254.10.1 is now unreachable and distribute packets and packet flows which would have been sent to virtual address 169.254.10.1 to the remaining reachable virtual IP addresses (169.254.11.0, 169.254.11.2, 169.254.11.3) to be processed by remaining security application instances 4102 to 4104. Packets are not sent to failed instances 4100 and 4101.

TABLE 3.3.3
Example correspondence between virtual IP addresses, routing
paths to the virtual IP addresses, MAC Addresses, I/O interface
labels and security application instances after additional failure
of security application instance 410₁.

| | | | | Security |
|---|---|---|---|---|
| | | | | Applica- |
| Virtual IP | | | I/O | tion |
| Destination | Routing Path | MAC Address | interface | Instance |
| 169.254.10.0 | 169.254.11.0 | 00:B0:D0:65:C2:05 | I/O₄ | 410₄ |
| 169.254.10.1 | REMOVED | NA | NA | NA |
| 169.254.10.2 | 169.254.11.2 | 00:B0:D0:65:C2:03 | I/O₂ | 410₂ |
| 169.254.10.3 | 169.254.11.3 | 00:B0:D0:65:C2:04 | I/O₃ | 410₃ |
| NA | NA | 00:B0:D0:65:C2:01 | I/O₀ | 410₀ |
| NA | 169.254.11.1 | 00:B0:D0:65:C2:02 | I/O₁ | 410₁ |

Table 3.3.4 illustrate the correspondence between virtual IP addresses, routing paths to the virtual IP addresses, MAC Addresses, I/O interface labels and security application instances of the security control point after after the recovery of security application instance 410₀.

The routing path to the previously unreachable virtual IP address 169.254.10.1 has been restored to its original value (169.254.11.1). This could be done by editing the routing table of packet switch 402. The MAC address corresponding to the restored routing path (169.254.11.1) has been changed to the MAC address of restored security application instance 4100. The correspondence could be done by editing the ARP table of packet switch 402.

Virtual IP address 169.254.10.1 is now reachable and packets and packet flows and previously redistributed to instances 4102 . . . 4104 now pass through and are processed by restored security application instance 4100.

TABLE 3.3.4
Example correspondence between virtual IP addresses,
routing paths to the virtual IP addresses, MAC Addresses,
I/O interface labels and security application instances after
recovery of security instance 410₀.

| | | | | Security |
|---|---|---|---|---|
| | | | | Applica- |
| Virtual IP | | | I/O | tion |
| Destination | Routing Path | MAC Address | interface | Instance |
| 169.254.10.0 | 169.254.11.0 | 00:B0:D0:65:C2:05 | I/O₄ | 410₄ |
| 169.254.10.1 | 169.254.11.1 | 00:B0:D0:65:C2:01 | I/O₀ | 410₀ |
| 169.254.10.2 | 169.254.11.2 | 00:B0:D0:65:C2:03 | I/O₂ | 410₂ |
| 169.254.10.3 | 169.254.11.3 | 00:B0:D0:65:C2:04 | I/O₃ | 410₃ |
| FAILED | | 00:B0:D0:65:C2:02 | I/O₁ | 410₁ |

The last remaining failed security application instance (410₁) could also recover. The last remaining failed security application instance could become the spare security application instance of the security application instance cluster.

For example, referring to FIG. 4, security application instance 4101 could recover and become a hot spare security application instance and not receive packet flows.

Table 3.3.5 illustrate the correspondence between virtual IP addresses, routing paths to the virtual IP addresses, MAC Addresses, I/O interface labels and security application instances of the security control point after the recovery of security application instance 4101. Previous hot spare security application instance 4104 remains in service and continues to process packet flows sent to corresponding virtual IP address 169.254.10.0.

TABLE 3.3.5
Example correspondence between virtual IP addresses, routing
paths to the virtual IP addresses, MAC Addresses, I/O
interface labels and security application instances after
recovery of security instance recovery 410₁

| | | | | Security |
|---|---|---|---|---|
| | | | | Applica- |
| Virtual IP | | | I/O | tion |
| Destination | Routing Path | MAC Address | interface | Instance |
| 169.254.10.0 | 169.254.11.0 | 00:B0:D0:65:C2:05 | I/O₄ | 410₄ |
| 169.254.10.1 | 169.254.11.1 | 00:B0:D0:65:C2:01 | I/O₀ | 410₀ |
| 169.254.10.2 | 169.254.11.2 | 00:B0:D0:65:C2:03 | I/O₂ | 410₂ |
| 169.254.10.3 | 169.254.11.3 | 00:B0:D0:65:C2:04 | I/O₃ | 410₃ |
| NA | NA | 00:B0:D0:65:C2:02 | I/O₁ | 410₁ |

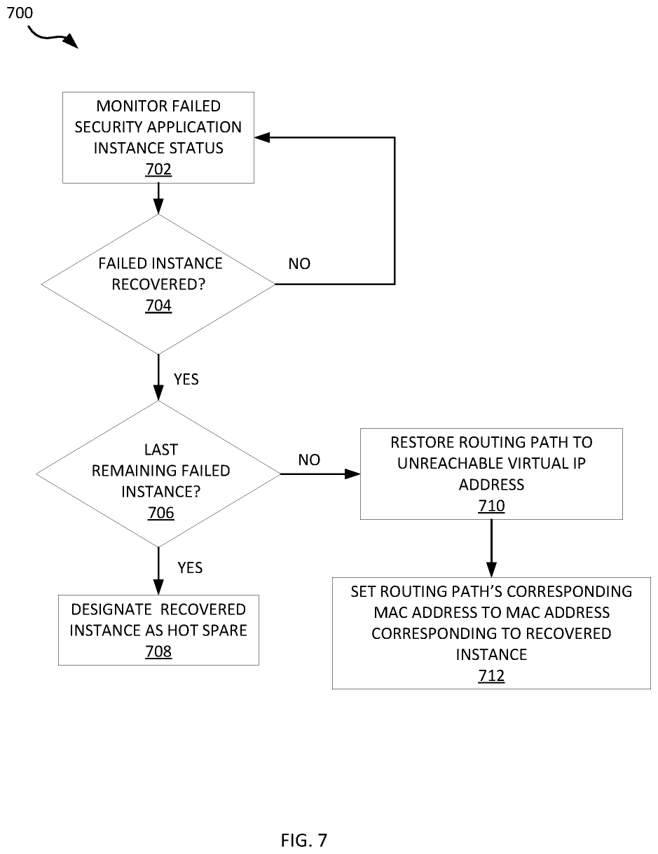

FIG. 7 is a flow diagram of a method of returning failed security application instances to service.

Method 700 begins at 702. At 702 the status of any failed security application instances is monitored. At 704 it is determined if any of the failed security application instances have recovered or been replaced. If no security application instances have recovered or been replaced (NO at 704) then the status of failed security application instances continues to be monitored at 702. The monitoring and determination could be done by a monitoring agent such as monitoring agent 404 of FIG. 4.

If a security application instance has recovered or been replaced with a working instance (YES at 704) then at 706 it is determined whether the recently recovered or replaced security application instance was the last remaining failed security application instance.

At 706 it is determined if the recovered security application instance is the last remaining instance. If the recovered or replaced security application instance is not the last remaining failed security application instance (NO at 706) then at 710 the routing path of an unreachable virtual IP address is restored to its original value. At 712 the routing path's corresponding MAC address is set to the MAC address corresponding to the recovered security application instance.

If the recovered security application instance is not the last remaining instance (YES at 706) then at 708 the recovered instance is designated as the spare instance.

Table 4 is a mapping table showing modulo result to security application instance mapping for failure and recovery sequence of multiple security application instances. In this example the modulo denominator is 16, there are five security application instances (FW0, FW1, FW2, FW3 and spare security application instance FW_SPARE).

Column 2 shows the modulo results mapping with security application instances FW0, FW1, FW2 and FW3 all working and processing packets. FW_SPARE is the designated spare security application instance and does not process packets.

Column 3 shows the modulo results mapping with security application instances FW0, FW1 and FW2 all working and security application instance FW3 failed. Modulo results 12 to 15 have been remapped to spare security application instance FW_SPARE and there is no longer a spare security application instance.

Column 4 shows the modulo results mapping with security application instances FW0 and FW1 working and security application instances FW3 and FW2 both failed. Modulo results 8 to 11 have been remapped to the three remaining working security application instances (FW1, FW2, FW_SPARE).

Column 5 shows the modulo results mapping with security application instances FW0 and FW1 both working, FW3 recovered and working and FW2 still failed. Modulo results 8 to 11 have been remapped to the recently recovered security application instance (FW3) from the remaining working security application instances (FW1, FW2, FW_SPARE).

Column 6 shows the modulo results mapping with security application instances FW0, FW1 and FW3 all working and FW2 recovered and working. Security application instance FW2 is now the designated spare for the security application instance cluster.

TABLE 4.0
Example mapping table showing the failure and recovery
of multiple security application instances.

| | Association | | | | |
|---|---|---|---|---|---|
| | with four | | | | |
| | working | | | | |
| | instances | Association | Association | Association | Association |
| Modulo | (FW0, FW1, | after FW3 | after FW2 and | after FW3 | after FW2 |
| result | FW2, FW3) | failed | FW3 failed | recovered | recovered |
| 0 | FW0 | FW0 | FW0 | FW0 | FW0 |
| 1 | FW0 | FW0 | FW0 | FW0 | FW0 |
| 2 | FW0 | FW0 | FW0 | FW0 | FW0 |
| 3 | FW0 | FW0 | FW0 | FW0 | FW0 |
| 4 | FW1 | FW1 | FW1 | FW1 | FW1 |
| 5 | FW1 | FW1 | FW1 | FW1 | FW1 |
| 6 | FW1 | FW1 | FW1 | FW1 | FW1 |
| 7 | FW1 | FW1 | FW1 | FW1 | FW1 |
| 8 | FW2 | FW2 | FW0 | FW3 | FW3 |
| 9 | FW2 | FW2 | FW1 | FW3 | FW3 |
| 10 | FW2 | FW2 | FW_SPARE | FW3 | FW3 |
| 11 | FW2 | FW2 | FW0 | FW3 | FW3 |
| 12 | FW3 | FW_SPARE | FW_SPARE | FW_SPARE | FW_SPARE |
| 13 | FW3 | FW_SPARE | FW_SPARE | FW_SPARE | FW_SPARE |
| 14 | FW3 | FW_SPARE | FW_SPARE | FW_SPARE | FW_SPARE |
| 15 | FW3 | FW_SPARE | FW_SPARE | FW_SPARE | FW_SPARE |
| SPARE | FW_SPARE | NONE | NONE | NONE | FW2 |

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g. “C”) or an object-oriented language (e.g. “C++”, “java”, “PHP”, “PYTHON” or “C#”). Alternative embodiments of the invention may be implemented as pre-programmed hardware elements, other related components, or as a combination of hardware and software components. Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for applying security protocols to packet flows passing between a pair of security zones, the system comprising:
a packet switch for receiving incoming packet flows from one of said pair of security zones and for transmitting secured packet flows to the other of said security zones, said secured packet flows being packet flows to which security protocols have been applied, said packet switch passing said incoming packet flows to one or more security protocol sub-systems and said packet switch receiving said secured packet flows from said one or more security protocol sub-system;
one or more of said security protocol subsystems, each one of said one or more of said security protocol subsystems being for receiving incoming packet flows from said packet switch, said one or more security protocol subsystems applying security protocols to said incoming packet flows to result in said secured packet flows, said secured packet flows being transmitted from said one or more of said security protocol subsystems to said packet switch; and
a controller for controlling said packet switch such that a routing of incoming packet flows to said one or more security protocol subsystems is controlled by said controller,
wherein
said controller adjusts a routing of said incoming packet flows to said one or more of said security protocol subsystems and manages said one or more of said security protocol subsystems by adjusting entries in tables in said packet switch; and
said adjusting entries in said tables adjusts a function of said packet switch for said incoming packet flows such that all packets in a specific incoming packet flow are routed to a specific one of said one or more security protocol subsystems.

2. The system according to claim 1, wherein said packet switch comprises:
one or more network traffic ports for receiving said incoming packet flows and for sending said secured packet flows, said at least one network traffic port being for communicating with said pair of security zones; and
one or more I/O ports for forwarding said incoming packet flows to said one or more security protocol subsystems and for receiving said secured packet flows from said one or more security protocol subsystems by way of at least one virtual interface,
wherein
there is a one-to-one correspondence between said one or more I/O ports and said one or more security protocol subsystems such that each I/O port uniquely corresponds to a specific one of said one or more security protocol subsystems.

3. The system according to claim 2, wherein said system implements a method for determining which I/O port to send said incoming packet flows to on said packet switch, said method comprising the steps of:
(a) receiving one of said incoming packet flows, each of said incoming packet flows comprising a plurality of data packets;
(b) for each specific packet of said plurality of data packets,
(b1) determining a virtual IP address for said specific packet based on a destination network of said specific packet;
(b2) based on said virtual IP address, determining a routing path IP address for said virtual IP address;
(b3) determining a MAC address for said routing path IP address;
(b4) determining a specific I/O interface that corresponds to said MAC address; and
(b5) routing said specific packet to said specific I/O interface determined in step (b4), wherein determining which specific I/O interface is to be used for routing said specific packet also determines which of said security protocol subsystems is to be used for applying security protocols to said specific packet.

4. The system according to claim 3, wherein, prior to step (b1), the following steps are executed:
(b1-1) determining a set of characteristics that said specific packet has in common with other packets such that said set of characteristics defines a unidirectional packet flow;
(b1-2) determining a directionally symmetric hash value from said set of characteristics; and
(b1-3) determining a modulo result from said symmetric hash value, said modulo result being a non-negative integer number,
and wherein
said virtual IP address for said specific packet is based on said destination network of said specific packet and on said modulo result for said specific packet.

5. The system according to claim 2, wherein said system implements a method for determining which I/O port to send said incoming packet flows to on said packet switch, said method comprising the steps of:
(a) receiving one of said incoming packet flows, each of said incoming packet flows comprising a plurality of data packets;
(b) for each specific packet of said incoming packet flows,
(b1) determining a virtual IP address for said specific packet based on a destination network of said specific packet;
(b2) determining a reachability of said virtual IP address;
(b3) in the event said virtual IP address is not reachable, determining an alternate virtual IP address and using said alternate virtual IP address as said virtual IP address;
(b4) based on said virtual IP address, determining a routing path IP address for said virtual IP address;
(b5) determining a MAC address for said routing path IP address;
(b6) determining a specific I/O interface that corresponds to said MAC address; and
(b7) routing said specific packet to said specific I/O interface determined in step b6),
wherein determining which specific I/O interface is to be used for routing said specific packet also determines which of said security protocol subsystems is to be used for applying security protocols to said specific packet.

6. The system according to claim 5, wherein said alternate virtual IP address is determined using resilient hashing.

7. The system according to claim 5, wherein prior to step (b1), the following steps are executed:
(b1-1) determining a set of characteristics that said specific packet has in common with other packets such that said set of characteristics defines a unidirectional packet flow;
(b1-2) determining a directionally symmetric hash value from said set of characteristics; and
(b1-3) determining a modulo result from said symmetric hash value, said modulo result being a non-negative integer number,
and
wherein a virtual IP address for said specific packet is based on a destination network of said specific packet and on said modulo result.

8. The system according to claim 2, wherein said system implements a method for managing said one or more security protocol subsystems, the method comprising:
(a) determining if a specific security protocol subsystem is to be designated as having a recovered status, said specific security protocol subsystem being previously determined to have failed;
(b) in the event said specific security protocol subsystem is to be designated as having said recovered status, designating said specific security protocol subsystem as a recovered security protocol subsystem;
(c) determining if said recovered security protocol subsystem is to be designated as a spare security protocol subsystem;
(d) in the event said recovered security protocol subsystem is to be designated as a spare security protocol subsystem, adjusting said tables such that said recovered security protocol subsystem is designated as a spare; and
(e) in the event said recovered security protocol subsystem is not designated as a spare security protocol subsystem, adjusting at least one table entry to thereby restore a specific routing path of a previously designated unreachable virtual IP address and adjusting at least one other table entry to thereby designate the MAC address corresponding to the recovered security protocol subsystem as corresponding to said specific routing path.

9. The system according to claim 2, wherein said controller monitors a status of said one or more security protocol subsystems and, when said controller initially determines that a specific security protocol subsystem has a failed status, said controller executes the following steps:
(aa) determining if a spare security protocol subsystem is already in use;
(ab) if said spare security protocol subsystem is already in use, editing one or more tables such that said specific security protocol subsystem that has said failed status is unreachable; and
(ac) if said spare security protocol subsystem is not already in use, editing one or more tables such that said spare security protocol subsystem is used by said system in place of said specific security protocol subsystem that has said failed status.

10. The system according to claim 9, wherein step (ab) is executed by editing one or more tables such that routing paths to virtual IP addresses that correspond to said specific security protocol subsystem that has said failed status are removed.

11. The system according to claim 9, wherein step (ac) is executed by editing one or more tables such that a MAC address corresponding to said specific security protocol subsystem that has said failed status are replaced by a MAC address corresponding to said spare security protocol subsystem.

12. The system according to claim 2, wherein said controller is external to said packet switch.

13. The system according to claim 12, wherein said controller is operating on an external server in communication with said packet switch, said packet switch receiving communications from said external server to thereby adjust said tables as necessary.

14. The system according to claim 2, wherein said tables include:
one or more routing tables that detail concordance between virtual IP addresses and routing paths;
one or more MAC address tables that detail a concordance between MAC addresses and said I/O ports;
one or more ARP tables that detail concordance between routing paths of virtual IP addresses and MAC addresses; and
one or more routing tables that detail a concordance between destination networks and virtual IP addresses.

15. The system according to claim 2, wherein in said tables, each destination network maps to at least one virtual IP address.

16. The system according to claim 15, wherein each virtual IP address maps to a routing path.

17. The system according to claim 16, wherein each of said routing path maps to a MAC addresses.

18. The system according to claim 2, wherein said controller manages security protocol subsystems by periodically causing monitoring packets to be sent to said one or more of said security protocol subsystems.

19. The system according to claim 18, wherein said controller determines a health of specific ones of said security protocol subsystems based on whether said monitoring packets are responded to or not and wherein said controller adjusts said tables, when necessary, such that packets are not sent to security protocol subsystems that are considered to be sub-optimal.

20. The system according to claim 19, wherein security protocol subsystems are considered to be sub-optimal when said security protocol subsystems are one or more of:
non-functional;
malfunctioning; and
equipped with out-of-date security protocols.

21. The system according to claim 19, wherein said controller replaces security protocol subsystems that are considered to be sub-optimal with one or more spare security protocol subsystems.

22. A method for determining which I/O interface to send incoming packet flows to on a packet switch, said method comprising the steps of:
(a) receiving one of said incoming packet flows, each of said incoming packet flows comprising a plurality of data packets;
(b) for each specific packet of said plurality of data packets in a specific incoming packet flow,
(b1) determining a virtual IP address for said specific packet based on a destination network of said specific packet;
(b2) based on said virtual IP address, determining a routing path IP address for said virtual IP address;
(b3) determining a MAC address for said routing path IP address;
(b4) determining a specific I/O interface that corresponds to said MAC address;
(b5) routing said specific packet in said specific incoming packet flow to said specific I/O interface determined in step (b4);
wherein determining which specific I/O interface is to be used for routing said specific incoming packet flow also determines which of said security protocol subsystems is to be used for applying security protocols to said packets in said specific incoming packet flow.

23. The method according to claim 22, wherein between steps (b1) and (b2), said method includes
(ba-1) determining a reachability of said virtual IP address; and
(ba-2) in the event said virtual IP address is not reachable, determining an alternate virtual IP address and using said alternate virtual IP address as said virtual IP address.

24. The method according to claim 22, wherein said method is implemented by a controller that controls a packet switch of which said I/O interface is a part.

25. The method according to claim 22, wherein prior to step (b1), the following steps are executed:
(b1-1) determining a set of characteristics that said specific packet has in common with other packets such that said set of characteristics define a unidirectional packet flow;
(b1-2) determining a symmetric hash value for said set of characteristics;
(b1-3) determining a modulo result on said symmetric hash value, said modulo result being a non-negative integer number result;
and
wherein a virtual IP address for said specific packet is based on a destination network of said specific packet and on said modulo result.

26. The method according to claim 25, wherein steps (b1-1) and (b1-3) are executed by dedicated hardware components of a system that includes said packet switch.

27. A method for determining which I/O interface to send incoming packet flows to on a packet switch, said method comprising the steps of:
(a) receiving one of said incoming packet flows, each of said incoming packet flows comprising a plurality of data packets;
(b) for each specific packet of said plurality of data packets in a specific incoming packet flow,
(b1) determining a virtual IP address for said specific packet based on a destination network of said specific packet;
(b2) determining a reachability of said virtual IP address;
(b3) in the event said virtual IP address is not reachable, determining an alternate virtual IP address and using said alternate virtual IP address as said virtual IP address;
(b4) based on said virtual IP address, determining a routing path IP address for said virtual IP address;
(b5) determining a MAC address for said routing path IP address;
(b6) determining a specific I/O interface that corresponds to said MAC address; and
(b7) routing said specific packet of said specific incoming packet flow to said specific I/O interface determined in step (b6),
wherein determining which specific I/O interface is to be used for routing said specific incoming packet flow also determines which of said security protocol subsystems is to be used for applying security protocols to said packets in said specific incoming packet flow.

28. The method according to claim 27, wherein said alternate virtual IP address is determined using resilient hashing.

29. The method according to claim 27, wherein prior to step (b1), the following steps are executed:
(b1-1) determining a set of characteristics that said specific packet has in common with other packets such that said set of characteristics define a unidirectional packet flow;
(b1-2) determining a symmetric hash value for said set of characteristics;
(b1-3) determining a modulo result on said symmetric hash value, said modulo result being a non-negative integer number;
and
wherein a virtual IP address for said specific packet based on a destination network of said specific packet and on said modulo result.

30. A method for managing said one or more security protocol subsystems used by a packet switch, the method comprising:
(a) determining if a specific security protocol subsystem is to be designated as having a recovered status, said specific security protocol subsystem being previously determined to have failed;
(b) in the event said specific security protocol subsystem is to be designated as having said recovered status, designating said specific security protocol subsystem as a recovered security protocol subsystem;
(c) determining if said recovered security protocol subsystem is to be designated as a spare security protocol subsystem;
(d) in the event said recovered security protocol subsystem is to be designated as a spare security protocol subsystem, adjusting tables in said packet switch such that said recovered security protocol subsystem is designated as a spare; and
(e) in the event said recovered security protocol subsystem is not designated as a spare security protocol subsystem, adjusting at least one table entry to thereby restore a specific routing path of a previously designated unreachable virtual IP address and adjusting at least one other table entry to thereby designate the MAC address corresponding to the recovered security protocol subsystem as corresponding to said specific routing path,
wherein said security protocol subsystems are for receiving incoming packet flows from said packet switch, said one or more security protocol subsystems applying security protocols to said incoming packet flows to result in secured packet flows, said secured packet flows being transmitted from said one or more of said security protocol subsystems to said packet switch.

31. A method for managing a group of security protocol subsystems used by a packet switch, said group including a spare security protocol subsystem for use when a failure of one of said group of security protocol subsystems is detected, said method comprising:
(a) determining if a spare security protocol subsystem is already in use;
(b) if said spare security protocol subsystem is already in use, editing one or more tables in a packet switch such that a specific security protocol subsystem that has failed is unreachable; and
(c) if said spare security protocol subsystem is not already in use, editing one or more tables in said packet switch such that said spare security protocol subsystem is used by said packet switch in place of said specific security protocol subsystem that has failed.

32. The method according to claim 31, wherein step (b) is executed by editing one or more tables in said packet switch such that the routing path of the virtual IP address that corresponds to said specific security protocol subsystem that has failed is removed.

33. The system according to claim 31, wherein step (c) is executed by editing one or more tables such that a MAC address corresponding to said specific security protocol subsystem that has said failed status is replaced by a MAC address corresponding to said spare security protocol subsystem.

34. The system according to claim 1, wherein at least one security protocol subsystem implements a hardware firewall.

35. The system according to claim 1, wherein said packet switch implements Equal Cost Multi-Path (ECMP) functionality and load balances across said one or more security protocol subsystems using said ECMP functionality.

36. The system according to claim 14, wherein each virtual IP address corresponds to a specific routing path and wherein each routing path corresponds to a specific MAC address.

37. The system according to claim 36, wherein each MAC address corresponds to a specific I/O interface.

38. The system according to claim 2, wherein said system includes a spare security protocol subsystem, said spare security protocol subsystem being for use in replacing a failed security protocol subsystem when said failed security protocol subsystem is detected by said controller.

39. The system according to claim 2, wherein at least one of said security protocol subsystems is a dedicated security appliance.

40. The system according to claim 5, wherein for step (b1), a same virtual IP address is determined for all packets in a particular incoming packet flow.

41. The method according to claim 22, wherein for step (b1), a same virtual IP address is determined for all packets in a particular incoming packet flow.

42. The method according to claim 27, wherein for step (b1), a same virtual IP address is determined for all packets in a particular incoming packet flow.
